(19) United States
(12) Patent Application Publication
(10) Pub. No.: US 2026/0332917 A1
(43) Pub. Date: Oct. 22, 2026

(54) PHOTOELECTRIC CONVERSION DEVICE

(71) Applicant: CANON KABUSHIKI KAISHA, Tokyo (JP)

(72) Inventor: KENZO TOJIMA, Tokyo (JP)

(21) Appl. No.: 19/467,236

(22) Filed: Feb. 2, 2026

(30) Foreign Application Priority Data
Feb. 13, 2025 (JP) 2025-021357

(51) Int. Cl. H04N 25/78; H04N 25/773

(52) U.S. Cl. CPC H04N 25/78; H04N 25/773

(57) ABSTRACT

A photoelectric conversion device includes an avalanche photodiode, a pulse generation circuit generating a pulsed signal based on an output signal from the avalanche photodiode, a counter generating and holding a first count value of N bits by counting the number of pulses included in the pulsed signal, where N is an integer equal to or greater than two, an illuminance determination circuit generating an illuminance signal based on a value of at least a part of bits of the first count value, a selector outputting a second count value of M bits in the first count value, where M is an integer equal to or greater than one and is less than N, and an output circuit outputting data based on the first or second count value. The selector selects a range of bits of the second count value in the first count value based on the illuminance signal.

### BACKGROUND

### Field of the Technology

The present disclosure relates to a photoelectric conversion device.

### Description of the Related Art

Japanese Patent Laid-Open No. 2021-093583 discloses a photoelectric conversion device in which a plurality of pixels each including an avalanche photodiode are arranged in a two-dimensional array. The photoelectric conversion device disclosed in Japanese Patent Laid-Open No. 2021-093583 outputs a count value indicating the number of photons when the illuminance is less than a predetermined value, and outputs a predetermined fixed value when the illuminance exceeds the predetermined value.

In a photoelectric conversion device that outputs a value according to illuminance as described in Japanese Patent Laid-Open No. 2021-093583, it is desired to make an output signal suitable.

### SUMMARY

Accordingly, an object of the present disclosure is to provide a photoelectric conversion device capable of outputting a more appropriate signal according to illuminance.

According to one aspect of the present disclosure, there is provided a photoelectric conversion device including an avalanche photodiode configured to output a signal according to incident light, a pulse generation circuit configured to generate a pulsed signal based on an output signal from the avalanche photodiode, a counter configured to generate and hold a first count value of N bits by counting the number of pulses included in the pulsed signal, where N is an integer equal to or greater than two, an illuminance determination circuit configured to generate an illuminance signal that indicates illuminance based on a value of at least a part of bits of the first count value, a selector configured to output a second count value of M bits in the first count value, where M is an integer equal to or greater than one, and M is less than N, and an output circuit configured to output data based on the first count value or the second count value. The selector selects a range of bits of the second count value in the first count value based on the illuminance signal.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating an overall configuration of a photoelectric conversion device according to a first embodiment.

FIG. 2 is a schematic block diagram illustrating a configuration example of a sensor substrate according to the first embodiment.

FIG. 3 is a schematic block diagram illustrating a configuration example of a circuit substrate according to the first embodiment.

FIG. 4 is a schematic block diagram illustrating a configuration example of one pixel of a photoelectric conversion unit and a pixel signal processing unit according to the first embodiment.

FIGS. 5A, 5B, and 5C are diagrams illustrating an operation of an avalanche photodiode according to the first embodiment.

FIG. 6 is a diagram illustrating a configuration example of pixel signal processing units of two adjacent pixels according to the first embodiment.

FIG. 7A is a diagram illustrating an operation in a non-high frame rate mode according to the first embodiment, and FIG. 7B is a diagram illustrating an operation in a high frame rate mode according to the first embodiment.

FIG. 8 is a timing chart illustrating an operation of pixel signal processing units of two adjacent pixels in the high frame rate mode according to the first embodiment.

FIG. 9 is a timing chart illustrating an operation of the pixel signal processing unit in the non-high frame rate mode according to the first embodiment.

FIG. 10 is a diagram illustrating a configuration example of the pixel signal processing unit according to a second embodiment.

FIG. 11A is a diagram illustrating an operation in the non-high frame rate mode according to the second embodiment, and FIG. 11B is a diagram illustrating an operation in the high frame rate mode according to the second embodiment.

FIG. 12 is a timing chart illustrating an operation of the pixel signal processing unit in the high frame rate mode according to the second embodiment.

FIG. 13 is a timing chart illustrating an operation of the pixel signal processing unit in the non-high frame rate mode according to the second embodiment.

FIG. 14 is a diagram illustrating a configuration example of the pixel signal processing unit according to a third embodiment.

FIG. 15 is a diagram illustrating a configuration example of an extraction circuit according to the third embodiment.

FIG. 16 is a diagram illustrating a configuration example of the pixel signal processing unit according to a fourth embodiment.

FIG. 17A is a diagram illustrating an operation in the non-high frame rate mode according to the fourth embodiment, and FIG. 17B is a diagram illustrating an operation in the high frame rate mode according to the fourth embodiment.

FIG. 18 is a diagram illustrating a configuration example of the extraction circuit according to the fourth embodiment.

FIG. 19 is a timing chart illustrating an operation of the pixel signal processing unit in the high frame rate mode according to the fourth embodiment.

FIG. 20 is a timing chart illustrating an operation of the pixel signal processing unit in the non-high frame rate mode according to the fourth embodiment.

FIG. 21 is a block diagram illustrating a schematic configuration of equipment according to a fifth embodiment.

FIGS. 22A and 22B are block diagrams illustrating a schematic configuration of equipment according to a sixth embodiment.

FIGS. 23A, 23B, and 23C are diagrams illustrating setting regions of the high frame rate mode and the non-high frame rate mode according to a ninth embodiment.

### DESCRIPTION OF THE EMBODIMENTS

Hereinafter, embodiments of the present disclosure will be described with reference to the drawings. The same or corresponding elements are denoted by the same reference numerals throughout the several drawings, and the description thereof may be omitted or simplified.

### First Embodiment

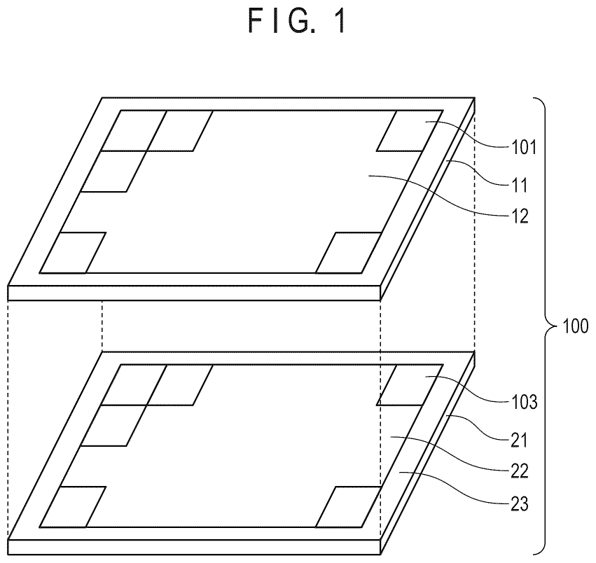

FIG. 1 is a schematic diagram illustrating an overall configuration of the photoelectric conversion device 100 according to the present embodiment. The photoelectric conversion device 100 includes a sensor substrate 11 (first substrate) and a circuit substrate 21 (second substrate) stacked. The sensor substrate 11 and the circuit substrate 21 are electrically connected to each other. The sensor substrate 11 has a pixel region 12 in which a plurality of pixel circuits 101 are arranged to form a plurality of rows and a plurality of columns. The circuit substrate 21 includes a first circuit region 22 in which a plurality of pixel signal processing units 103 are arranged to form a plurality of rows and a plurality of columns, and a second circuit region 23 arranged outside the first circuit region 22. The second circuit region 23 may include a circuit for controlling the plurality of pixel signal processing units 103. The sensor substrate 11 has a light incident surface for receiving incident light and a connection surface opposed to the light incident surface. The sensor substrate 11 is connected to the circuit substrate 21 on the connection surface side. That is, the photoelectric conversion device 100 is a so-called backside illumination type.

In this specification, the term “plan view” refers to a view from a direction perpendicular to a surface opposite to the light incident surface. The cross section indicates a surface in a direction perpendicular to a surface opposite to the light incident surface of the sensor substrate 11. Although the light incident surface may be a rough surface when viewed microscopically, in this case, a plan view is defined with reference to the light incident surface when viewed macroscopically.

In the following description, the sensor substrate 11 and the circuit substrate 21 are diced chips, but the sensor substrate 11 and the circuit substrate 21 are not limited to chips. For example, the sensor substrate 11 and the circuit substrate 21 may be wafers. When the sensor substrate 11 and the circuit substrate 21 are diced chips, the photoelectric conversion device 100 may be manufactured by being diced after being stacked in a wafer state, or may be manufactured by being stacked after being diced.

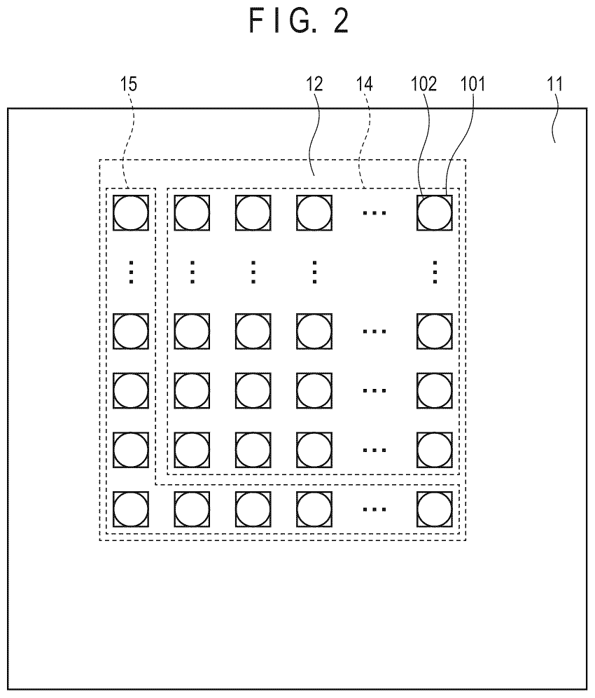

FIG. 2 is a schematic block diagram illustrating an arrangement example of the sensor substrate 11. In the pixel region 12, a plurality of pixels 101 are arranged to form a plurality of rows and a plurality of columns. Each of the plurality of pixels 101 includes a photoelectric conversion unit 102 including an avalanche photodiode (hereinafter referred to as APD) as a photoelectric conversion element in the substrate.

Each of the plurality of pixels 101 typically generates a signal constituting an image. However, when the photoelectric conversion device 100 is used in a time of flight (TOF) type ranging device, the generated signal does not necessarily used to constitute an image. That is, each of the plurality of pixels 101 may generate a signal for measuring the time at which light reaches to the pixel and the amount of light.

Of the charge pairs generated in the APD, the conductivity type corresponding to the charge used as the signal charge is referred to as a first conductivity type. The first conductivity type refers to a conductivity type in which a charge having the same polarity as the signal charge is a majority carrier. Further, a conductivity type opposite to the first conductivity type, that is, a conductivity type in which a majority carrier is a charge having a polarity different from that of a signal charge is referred to as a second conductivity type. In the APD described below, the anode of the APD is set to a fixed potential, and a signal is extracted from the cathode of the APD. Accordingly, the semiconductor region of the first conductivity type is an N-type semiconductor region, and the semiconductor region of the second conductivity type is a P-type semiconductor region. Note that the cathode of the APD may have a fixed potential and a signal may be extracted from the anode of the APD. In this case, the semiconductor region of the first conductivity type is the P-type semiconductor region, and the semiconductor region of the second conductivity type is then N-type semiconductor region. Although the case where one node of the APD is set to a fixed potential is described below, potentials of both nodes may be varied.

The pixel region 12 includes a light receiving region 14 and an optical black region (hereinafter referred to as an “OB region”) 15. The pixels 101 in the light receiving region 14 generate signals according to incident light. A light shielding film that blocks incident light is arranged over the photoelectric conversion unit 102 in the OB region 15. Accordingly, the pixel 101 in the OB region 15 generates a signal of a black level corresponding to a case where there is no incident light. The OB region 15 is typically arranged along two sides around the light receiving region 14. In the example of FIG. 2, the OB region 15 is arranged to form an L-shaped region along the left side and the lower side of the light receiving region 14. The arrangement of the light receiving region 14 and the OB region 15 is not particularly limited.

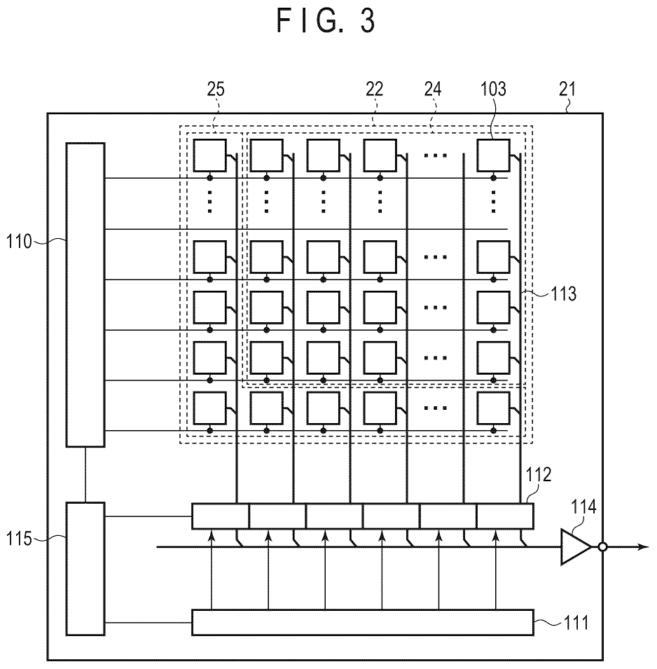

FIG. 3 is a schematic block diagram illustrating a configuration example of the circuit substrate 21. The circuit substrate 21 has the first circuit region 22 in which a plurality of pixel signal processing units 103 are arranged to form a plurality of rows and a plurality of columns. A region 24 in FIG. 3 indicates an area in which the pixel signal processing units 103 corresponding to the pixels 101 of the light receiving region 14 are arranged. A region 25 in FIG. 3 indicates an area in which the pixel signal processing units 103 corresponding to the pixels 101 in the OB region 15 are arranged.

The circuit substrate 21 includes a vertical scanning circuit 110, a horizontal scanning circuit 111, a reading circuit 112, a pixel output signal line 113, an output circuit 114, and a control signal generation unit 115. The plurality of photoelectric conversion units 102 illustrated in FIG. 2 and the plurality of pixel signal processing units 103 illustrated in FIG. 3 are electrically connected to each other via connection wirings provided for the respective pixels 101.

The control signal generation unit 115 is a control circuit that generates control signals for driving the vertical scanning circuit 110, the horizontal scanning circuit 111, and the reading circuit 112 and supplies the control signals to these units. As a result, the control signal generation unit 115 controls the driving timings and the like of each unit.

The vertical scanning circuit 110 supplies control signals to each of the plurality of pixel signal processing units 103 based on the control signal supplied from the control signal generation unit 115. The vertical scanning circuit 110 supplies control signals for each row to the pixel signal processing unit 103 via a driving line provided for each row of the first circuit region 22. As will be described later, a plurality of driving lines may be provided for each row. A logic circuit such as a shift register or an address decoder can be used for the vertical scanning circuit 110. Thus, the vertical scanning circuit 110 selects a row to be output a signal from the pixel signal processing unit 103.

The signal output from the photoelectric conversion unit 102 of the pixel circuit 101 is processed by the pixel signal processing unit 103. The pixel signal processing unit 103 acquires and holds a digital signal having a plurality of bits by counting the number of pulses output from the APD included in the photoelectric conversion unit 102.

The horizontal scanning circuit 111 supplies control signals to the reading circuit 112 based on a control signal supplied from the control signal generation unit 115. The pixel signal processing unit 103 is connected to the reading circuit 112 via a pixel output signal line 113 provided for each column of the first circuit region 22. The pixel output signal line 113 in one column is shared by a plurality of pixel signal processing units 103 in the corresponding column. The pixel output signal line 113 includes a plurality of wirings, and has at least a function of outputting a digital signal from the pixel signal processing unit 103 to the reading circuit 112, and a function of supplying a control signal for selecting a column for outputting a signal to the pixel signal processing unit 103. The reading circuit 112 outputs a signal to a storage unit or a signal processing unit outside the photoelectric conversion device 100 via the output circuit 114 based on the control signal supplied from the control signal generation unit 115.

The photoelectric conversion units 102 in the pixel region 12 may be one-dimensionally arranged. In addition, the pixel signal processing unit 103 does not necessarily have to be provided one by one in all the pixels 101. For example, one pixel signal processing unit 103 may be shared by a plurality of pixels 101. In this case, the pixel signal processing unit 103 sequentially processes the signals output from the photoelectric conversion units 102, thereby providing the function of signal processing to each pixel 101.

As illustrated in FIGS. 2 and 3, the first circuit region 22 having a plurality of pixel signal processing units 103 is arranged in a region overlapping the pixel region 12 in the plan view. In the plan view, the vertical scanning circuit 110, the horizontal scanning circuit 111, the reading circuit 112, the output circuit 114, and the control signal generation unit 115 are arranged so as to overlap a region between an edge of the sensor substrate 11 and an edge of the pixel region 12. In other words, the sensor substrate 11 includes the pixel region 12 and a non-pixel region arranged around the pixel region 12. In the circuit substrate 21, the second circuit region 23 (described above in FIG. 1) having the vertical scanning circuit 110, the horizontal scanning circuit 111, the reading circuit 112, the output circuit 114, and the control signal generation unit 115 is arranged in a region overlapping with the non-pixel region in the plan view.

Note that the arrangement of the pixel output signal line 113, the arrangement of the reading circuit 112, and the arrangement of the output circuit 114 are not limited to those illustrated in FIG. 3. For example, the pixel output signal lines 113 may extend in the row direction, and may be shared by a plurality of pixel signal processing units 103 in corresponding rows. The reading circuit 112 may be provided so as to be connected to the pixel output signal line 113 of each row.

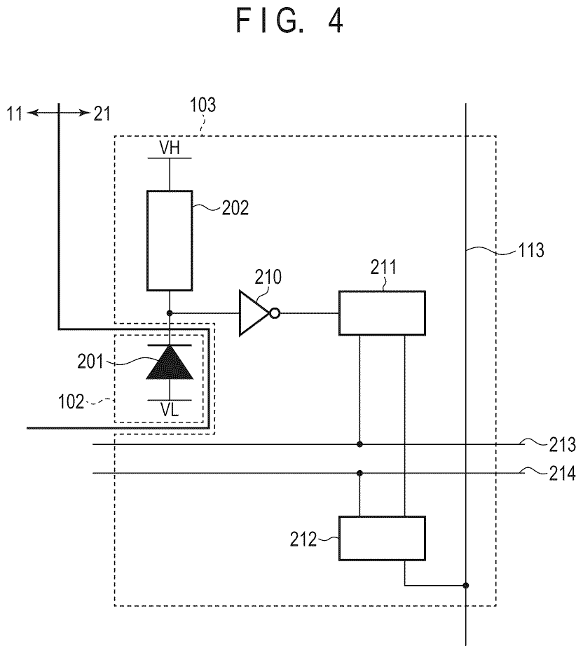

FIG. 4 is a schematic block diagram illustrating a configuration example of one pixel of the photoelectric conversion unit 102 and the pixel signal processing unit 103 according to the present embodiment. FIG. 4 schematically illustrates a more specific configuration example including a connection relationship between the photoelectric conversion unit 102 arranged in the sensor substrate 11 and the pixel signal processing unit 103 arranged in the circuit substrate 21. In FIG. 4, driving lines between the vertical scanning circuit 110 and the pixel signal processing unit 103 in FIG. 3 are illustrated as driving lines 213 and 214.

The photoelectric conversion unit 102 includes an APD 201. The pixel signal processing unit 103 includes a quenching element 202, a waveform shaping unit 210, a counter circuit 211, and a selection circuit 212.

The APD 201 generates charges corresponding to incident light by photoelectric conversion. A voltage VL (first voltage) is supplied to the anode of the APD 201. The cathode of the APD 201 is connected to a first terminal of the quenching element 202 and an input terminal of the waveform shaping unit 210. A voltage VH (second voltage) higher than the voltage VL supplied to the anode is supplied to the cathode of the APD 201. As a result, a reverse bias voltage that causes the APD 201 to perform the avalanche multiplication operation is supplied to the anode and the cathode of the APD 201. In the APD 201 to which the reverse bias voltage is supplied, when a charge is generated by the incident light, this charge causes avalanche multiplication, and an avalanche current is generated.

The operation modes in the case where a reverse bias voltage is supplied to the APD 201 include a Geiger mode and a linear mode. The Geiger mode is a mode in which a potential difference between the anode and the cathode is higher than a breakdown voltage, and the linear mode is a mode in which a potential difference between the anode and the cathode is near or lower than the breakdown voltage.

The APD operated in the Geiger mode is referred to as a single photon avalanche diode (SPAD). In this case, for example, the voltage VL (first voltage) is −30 V, and the voltage VH (second voltage) is 1 V. The APD 201 may operate in the linear mode or the Geiger mode. In the case of the SPAD, a potential difference becomes greater than that of the APD of the linear mode, and the effect of avalanche multiplication becomes significant, so that the SPAD is preferable.

The quenching element 202 functions as a load circuit (quenching circuit) when a signal is multiplied by avalanche multiplication. The quenching element 202 suppresses the voltage supplied to the APD 201 and suppresses the avalanche multiplication (quenching operation). Further, the quenching element 202 returns the voltage supplied to the APD 201 to the voltage VH by passing a current corresponding to the voltage drop due to the quenching operation (recharge operation). The quenching element 202 may be, for example, a resistive element.

The waveform shaping unit 210 shapes the potential change of the cathode of the APD 201 obtained at the time of photon detection, and outputs a pulsed signal. For example, an inverter circuit is used as the waveform shaping unit 210. Although FIG. 4 illustrates an example in which one inverter is used as the waveform shaping unit 210, the waveform shaping unit 210 may be a circuit in which a plurality of inverters are connected in series, or may be another circuit having a waveform shaping effect.

The counter circuit 211 counts the pulsed signal output from the waveform shaping unit 210 and holds a digital signal indicating the count value. When a control signal is supplied from the vertical scanning circuit 110 through the driving line 213, the counter circuit 211 resets the signal held therein.

The selection circuit 212 is supplied with a control signal from the vertical scanning circuit 110 illustrated in FIG. 3 through the driving line 214 illustrated in FIG. 4. In response to this control signal, the selection circuit 212 switches between the electrical connection and the non-connection of the counter circuit 211 and the pixel output signal line 113. The selection circuit 212 includes, for example, a buffer circuit or the like for outputting a signal corresponding to a value held in the counter circuit 211.

In the example of FIG. 4, the selection circuit 212 switches between the electrical connection and the non-connection of the counter circuit 211 and the pixel output signal line 113; however, the method of controlling the signal output to the pixel output signal line 113 is not limited thereto. For example, a switch such as a transistor may be arranged at a node such as between the quenching element 202 and the APD 201 or between the photoelectric conversion unit 102 and the pixel signal processing unit 103, and the signal output to the pixel output signal line 113 may be controlled by switching the electrical connection and the non-connection. Alternatively, the signal output to the pixel output signal line 113 may be controlled by changing the value of the voltage VH or the voltage VL supplied to the photoelectric conversion unit 102 using a switch such as a transistor.

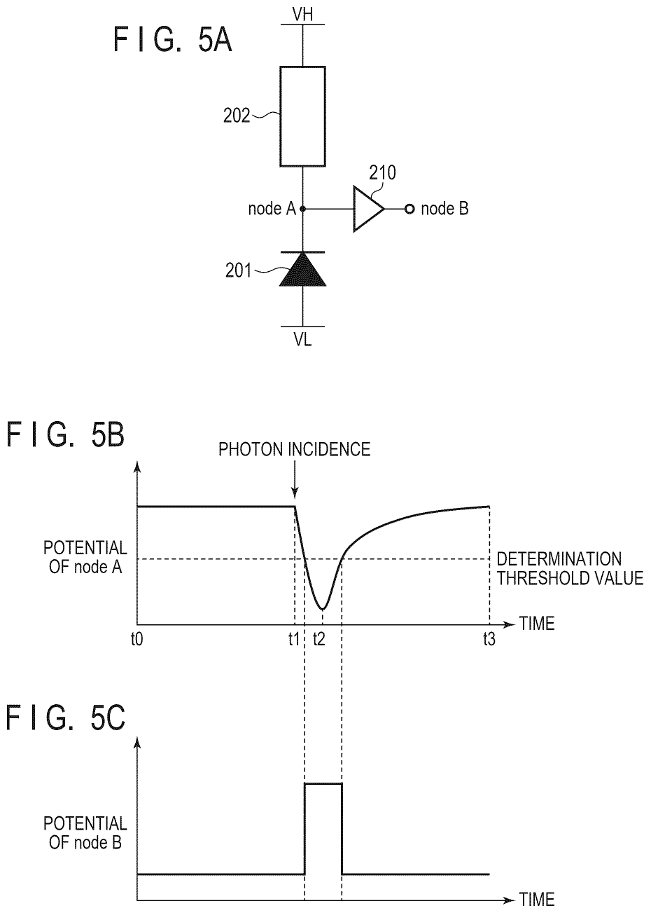

FIGS. 5A, 5B, and 5C are diagrams illustrating an operation of the APD 201 according to the present embodiment. FIG. 5A is a diagram illustrating the APD 201, the quenching element 202, and the waveform shaping unit 210 in FIG. 4. As illustrated in FIG. 5A, the connection node of the APD 201, the quenching element 202, and the input terminal of the waveform shaping unit 210 is referred to as node A. Further, as illustrated in FIG. 5A, an output side of the waveform shaping unit 210 is referred to as node B.

FIG. 5B is a graph illustrating a temporal change in the potential of node A in FIG. 5A. FIG. 5C is a graph illustrating a temporal change in the potential of node B in FIG. 5A. During a period from time t0 to time t1, the voltage VH-VL is applied to the APD 201 in FIG. 5A. When a photon enters the APD 201 at the time t1, avalanche multiplication occurs in the APD 201. As a result, an avalanche current flows through the quenching element 202, and the potential of the node A drops. Thereafter, the amount of potential drop further increases, and the voltage applied to the APD 201 gradually decreases. Then, at time t2, the avalanche multiplication in the APD 201 stops. Thereby, the voltage level of node A does not drop below a certain constant value. Then, during a period from the time t2 to time t3, a current that compensates for the voltage drop flows from the node of the voltage VH to the node A, and the node A is settled to the original potential at the time t3.

In the above-described process, the potential of node B becomes the high level in a period in which the potential of node A is lower than a certain threshold value. In this way, the waveform of the drop of the potential of the node A caused by the incidence of the photon is shaped by the waveform shaping unit 210 and output as a pulse to the node B.

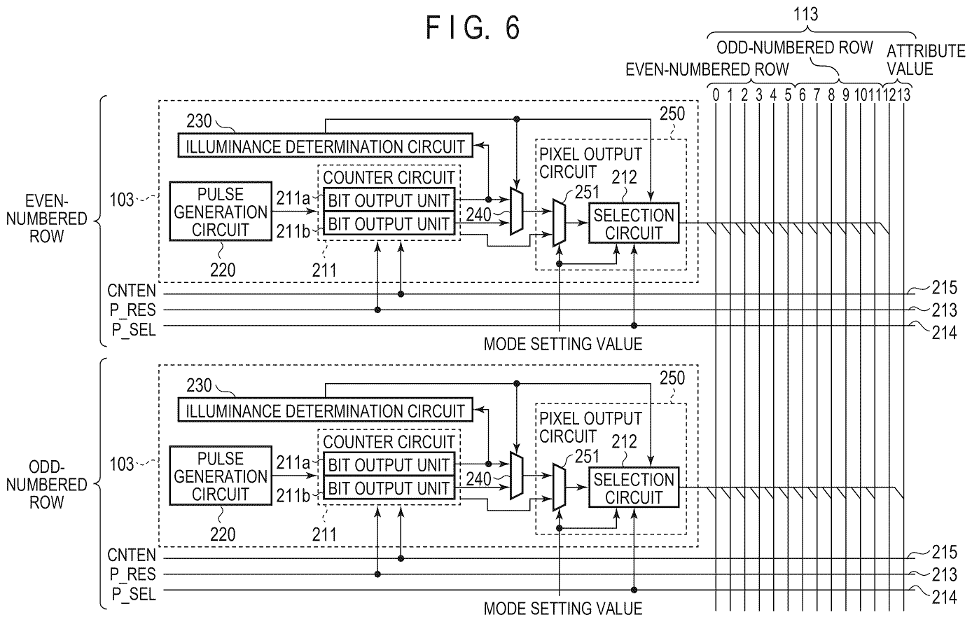

FIG. 6 is a diagram illustrating a configuration example of the pixel signal processing units 103 of two adjacent pixels according to the present embodiment. FIG. 6 illustrates the configuration of two pixel signal processing units 103 among the plurality of pixel signal processing units 103 arranged two-dimensionally in more detail. The pixel signal processing unit 103 includes a counter circuit 211, a pulse generation circuit 220, an illuminance determination circuit 230, a selector 240, and a pixel output circuit 250. FIG. 6 illustrates one of the plurality of pixel signal processing units 103 arranged in the even-numbered rows and one of the plurality of pixel signal processing units 103 arranged in the odd-numbered rows.

The pulse generation circuit 220 includes the quenching element 202 and the waveform shaping unit 210 illustrated in FIG. 4. The counter circuit 211 includes a bit output unit 211a and a bit output unit 211b. The pixel output circuit 250 includes a selector 251 and the selection circuit 212 illustrated in FIG. 4. FIG. 6 also illustrates a driving line 215 for supplying a drive signal CNTEN for controlling the operation of the counter circuit 211, and 14 signal lines constituting the pixel output signal line 113.

The counter circuit 211 generates and holds a count value (first count value) by counting the number of pulses included in the pulsed signal output from the pulse generation circuit 220. When a control pulse P_RES is supplied from the control signal generation unit 115 via the vertical scanning circuit 110 and the driving line 213, the counter circuit 211 resets the count value held therein. The counter circuit 211 starts counting at a timing when the drive signal CNTEN supplied from the control signal generation unit 115 via the vertical scanning circuit 110 and the driving line 215 becomes the high level. After that, the counter circuit 211 ends the counting at a timing when the drive signal CNTEN becomes the low level. That is, the drive signal CNTEN controls an exposure period. The counter circuit 211 is, for example, a 12-bit counter.

When the counter circuit 211 is a 12-bit counter, for example, the bit output unit 211a is configured to output upper 6-bit data of a signal held in the 12-bit counter. The bit output unit 211b is configured to output lower 6-bit data of the signal held in the 12-bit counter. As described above, the counter circuit 211 can divide the 12-bit data held therein into two ranges (the first range and the second range) of the upper six bits and the lower six bits and output them. In the present embodiment, the range of bits output by the bit output unit 211a and the range of bits output by the bit output unit 211b are set so as not to overlap with each other, but they may overlap with each other. Of the 12-bit data, the least significant bit (LSB) is the zeroth bit, and the most significant bit (MSB) is the eleventh bit.

The upper 6-bit data output from the bit output unit 211a is input to the illuminance determination circuit 230. The illuminance determination circuit 230 generates an illuminance signal indicating illuminance based on the 6-bit data being input, and outputs the illuminance signal to the selector 240 and the selection circuit 212 as a control signal. When the value of at least one bit of the 6-bit data is “1”, the illuminance determination circuit 230 outputs a control signal indicating “1” to the selector 240 and the selection circuit 212. When the above condition is not satisfied, the illuminance determination circuit 230 outputs a control signal indicating “0” to the selector 240 and the selection circuit 212. That is, when the illuminance is high enough that the count value of the 12-bit counter of the counter circuit 211 reaches the upper six bits, the illuminance determination circuit 230 outputs the control signal indicating “1”. The illuminance determination circuit 230 may include, for example, an OR circuit that calculates a logical sum of values of bits of 6-bit data. The OR circuit outputs a signal indicating “0” when all of the six input bits are zero, and outputs a signal indicating “1” otherwise.

The bit output unit 211a and the bit output unit 211b are connected to two input terminals of the selector 240, respectively. When the control signal indicating “1″ is input to the selector 240 from the illuminance determination circuit 230, the selector 240 selects and outputs the upper 6-bit data output from the bit output unit 211a. When the control signal indicating ”0″ is input to the selector 240 from the illuminance determination circuit 230, the selector 240 selects and outputs the lower 6-bit data output from the bit output unit 211b.

The pixel output circuit 250 expands the 6-bit data (second count value) output from the selector 240 to 12-bit data and inputs the 12-bit data to the selector 251. The expansion method is different between the pixel signal processing unit 103 in the even-numbered row and the pixel signal processing unit 103 in the odd-numbered row. For example, in the pixel signal processing unit 103 in the even-numbered row, the 6-bit data output from the selector 240 is stored in the lower six bits of the expanded 12-bit data. On the other hand, in the pixel signal processing unit 103 of the odd-numbered rows, the 6-bit data output from the selector 240 is stored in the upper six bits of the expanded 12-bit data.

To two input terminals of the selector 251, the 12-bit data obtained by expanding the 6-bit data output from the selector 240 and the 12-bit data indicating the count value held in the counter circuit 211 are input, respectively. The selector 251 is controlled by a mode setting value input from an external system (not illustrated) or the like. The mode setting value indicates whether the photoelectric conversion device 100 operates in a high frame rate mode.

When the operation of the photoelectric conversion device 100 is not in the high frame rate mode, the selector 251 selects the 12-bit data indicating the count value held in the counter circuit 211 and outputs the data to the selection circuit 212. When the operation of the photoelectric conversion device 100 is in the high frame rate mode, the selector 251 selects and outputs the 12-bit data obtained by expanding the 6-bit data output from the selector 240. As described above, in the pixel signal processing unit 103 in the even-numbered row, the valid data is stored in the lower six bits of the expanded 12-bit data, and in the pixel signal processing unit 103 in the odd-numbered row, the valid data is stored in the upper six bits of the expanded 12-bit data.

The selection circuit 212 switches between electrical connection and disconnection between the selector 251 and the illuminance determination circuit 230, and the pixel output signal line 113 by a control pulse P_SEL supplied from the control signal generation unit 115 via the vertical scanning circuit 110 and the driving line 214. The selection circuit 212 includes, for example, a buffer circuit for outputting a signal.

The selection circuit 212 is also controlled by the mode setting value in the same manner as the selector 251. First, a case where the operation of the photoelectric conversion device 100 is not in the high frame rate mode will be described. In this case, when the row is selected by the control pulse P_SEL, the selection circuit 212 connects the signal lines for transmitting the 12-bit data output from the selector 251 to signal lines of the zeroth bit to the eleventh bit of the pixel output signal line 113, respectively. The numbers “0” to “13” illustrated in the 14 signal lines constituting the pixel output signal line 113 in FIG. 6 indicate that these signal lines transmit data of the zeroth bit to the thirteenth bit, respectively.

A case where the operation of the photoelectric conversion device 100 is in the high frame rate mode will be described. The connection method in this case is different between a case where the pixel signal processing unit 103 in the even-numbered row is selected by the control pulse P_SEL and a case where the pixel signal processing unit 103 in the odd-numbered row is selected by the control pulse P_SEL.

The selection circuit 212 of the pixel signal processing unit 103 in the even-numbered row connects the signal lines of the lower six bits, which are valid data among the 12-bit data output from the selector 251, to the signal lines of the zeroth bit to the fifth bit of the pixel output signal line 113, respectively. In addition, the selection circuit 212 of the pixel signal processing unit 103 in the even-numbered row connects the signal line transmitting the 1-bit control signal output from the illuminance determination circuit 230 to the signal line of the twelfth bit of the pixel output signal line 113. By referring to the value of the twelfth bit of the pixel output signal line 113 as an attribute value, a processing circuit that performs the subsequent processing can determine whether the data read from the even-numbered row is the count value output from the bit output unit 211a or the bit output unit 211b.

The selection circuit 212 of the pixel signal processing unit 103 in the odd-numbered row connects the signal lines of the upper six bits, which are valid data among the 12-bit data output from the selector 251, to the signal lines of the sixth bit to the eleventh bit of the pixel output signal line 113, respectively. In addition, the selection circuit 212 of the pixel signal processing unit 103 in the odd-numbered row connects the signal line transmitting the 1-bit control signal output from the illuminance determination circuit 230 to the signal line of the thirteenth bit of the pixel output signal line 113. By referring to the value of the thirteenth bit of the pixel output signal line 113 as an attribute value, the processing circuit that performs the subsequent processing can determine whether the data read from the odd-numbered row is the count value output from the bit output unit 211a or the bit output unit 211b.

As described above, in the high frame rate mode, the signal lines of the zeroth bit to the fifth bit of the pixel output signal line 113 are used for the even-numbered rows, and the signal lines of the sixth bit to the eleventh bit of the pixel output signal line 113 are used for the odd-numbered rows. The signal lines of the twelfth bit and the thirteenth bit of the pixel output signal line 113 are used for the attribute values. However, this is an example, and for example, the signal lines of the zeroth bit to the fifth bit of the pixel output signal line 113 may be used for the odd-numbered rows, and the signal lines of the sixth bit to the eleventh bit of the pixel output signal line 113 may be used for the even-numbered rows.

As described above, in the high frame rate mode, since the pixel output signal line 113 is shared by the plurality of pixel signal processing units 103 in one column, the signal lines of the zeroth bit to the eleventh bit of the pixel output signal line 113 are shared by the pixel signal processing units 103 in the even-numbered row and the odd-numbered row. However, this configuration is merely an example, and the pixel output signal line 113 may be shared by the plurality of pixel signal processing units 103 in one row. In this case, the signal lines of the zeroth bit to the eleventh bit of the pixel output signal line 113 can be shared by the pixel signal processing units 103 of the even-numbered column and the odd-numbered column.

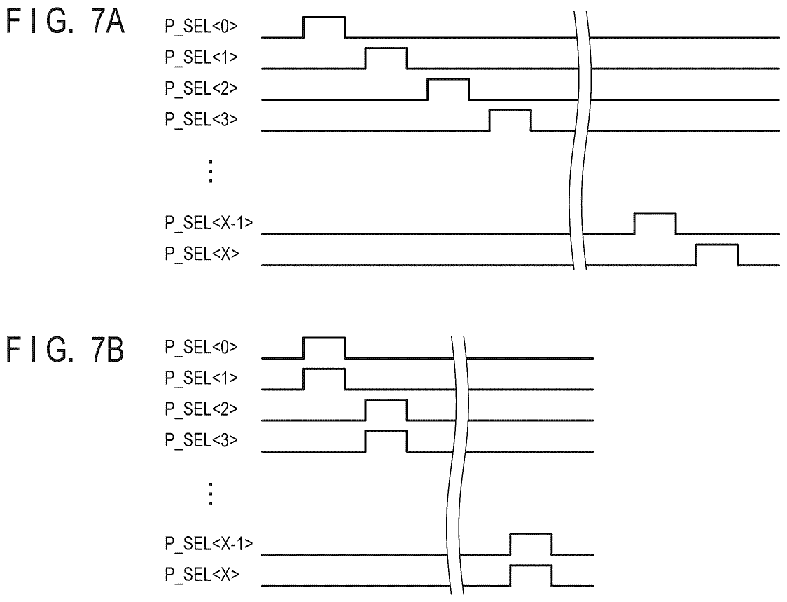

FIGS. 7A and 7B are diagrams illustrating the operations in the high frame rate mode and the non-high frame rate mode according to the present embodiment. FIGS. 7A and 7B illustrate temporal changes of a control pulse P_SEL<0> of the zeroth row to a control pulse P_SEL<X> of the X-th row. The numerical values in the angle brackets indicate the row numbers of the pixel signal processing units 103 to which the control pulses P_SEL are supplied.

FIG. 7A illustrates a reading operation in the non-high frame rate mode (second mode). In the non-high frame rate mode, the selection circuit 212 of the selected row connects the signal lines for transmitting the 12-bit data output from the selector 251 to the signal lines of the zeroth bit to the eleventh bit of the pixel output signal line 113, respectively. That is, all of the signal lines of the zeroth bit to the eleventh bit of the pixel output signal line 113 are occupied at the time of reading of one row. Accordingly, the control pulses P_SEL<0>, P_SEL<1>, P_SEL<2>, P_SEL<3>, . . . , P_SEL<X−1>, and P_SEL<X> sequentially become the high level, whereby reading is performed row by row.

FIG. 7B illustrates a reading operation in the high frame rate mode (first mode). In the high frame rate mode, different operations are performed in a case where the selected row is the even-numbered row and in a case where the selected row is an odd-numbered row. The selection circuit 212 of the pixel signal processing unit 103 in the even-numbered row connects the signal lines of the lower six bits, which are valid data among the 12-bit data output from the selector 251, to the signal lines of the zeroth bit to the fifth bit of the pixel output signal line 113, respectively. The selection circuit 212 of the pixel signal processing unit 103 in the odd-numbered row connects the signal lines of the upper six bits, which are valid data among the 12-bit data output from the selector 251, to the signal lines of the sixth bit to the eleventh bit of the pixel output signal line 113, respectively. That is, it is possible to share the signal lines of the zeroth bit to the eleventh bit of the pixel output signal line 113 at the time of reading the two rows of the even number and the odd number. Therefore, first, the control pulses P_SEL<0> and P_SEL<1> become the high level at the same time, and then the control pulses P_SEL<2> and P_SEL<3> become the high level at the same time. By performing such operations sequentially, reading is performed two rows at a time. As described above, in the high frame rate mode of the present embodiment, simultaneous readout of a plurality of rows is possible. As a result, as compared with the case of the non-high frame rate mode, in the high frame rate mode, the readout time becomes one half, so that the readout speed is doubled. Therefore, in the high frame rate mode, imaging can be performed at a frame rate higher than that in the non-high frame rate mode.

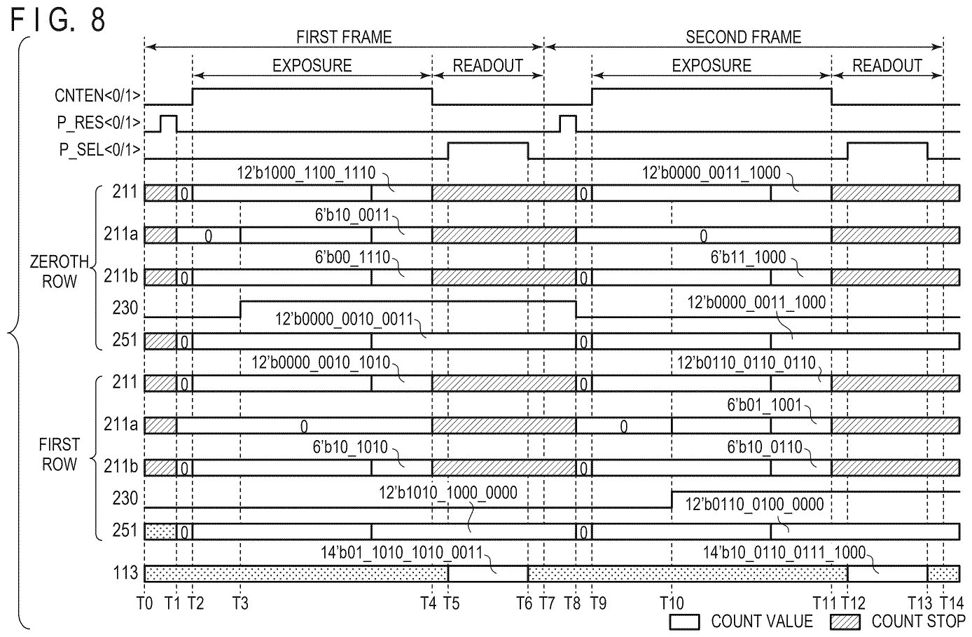

FIG. 8 is a timing chart illustrating an operation of the pixel signal processing units 103 of two adjacent pixels in the high frame rate mode according to the present embodiment. FIG. 8 illustrates temporal changes of the drive signal CNTEN<0/1> and temporal changes of the control pulses P_RES<0/1> and P_SEL<0/1> of the zeroth row and the first row. Further, FIG. 8 illustrates temporal changes of the count value in each unit of the pixel signal processing unit 103 and temporal changes of the control signal output from the illuminance determination circuit 230. The operations of the second and subsequent even-numbered rows are the same as the operation of the zeroth row, and the operations of the third and subsequent odd-numbered rows are the same as the operation of the first row, and thus description thereof is omitted. Note that the notation “0/1” in the angle brackets indicates that signals of the same level are supplied to the zeroth row and the first row.

At time T0, a first frame period starts. After the time T0, the control pulse P_RES<0/1> becomes the high level, and thereafter, at time T1, the control pulse P_RES<0/1> becomes the low level. As a result, the count value held in the counter circuit 211 is reset to “0”. Therefore, the count values output from the bit output units 211a and 211b are also reset to “0”.

At time T2, the drive signal CNTEN<0/1> becomes the high level, and the count operation in the counter circuit 211 starts. That is, the time T2 is the start time of an exposure period. At the time T2, the count value of the bit output unit 211b corresponding to the lower six bits of the counter circuit 211 starts to increase.

At time T3, a value is carried to the LSB of the upper six bits of the counter circuit 211 of the zeroth row. As a result, the count value of the bit output unit 211a corresponding to the upper six bits of the counter circuit 211 of the zeroth row starts to increase. Further, at the time T3, since one of the upper six bits of the counter circuit 211 of the zeroth row becomes “1”, the value of the control signal output from the illuminance determination circuit 230 of the zeroth row also becomes “1”.

At time T4, the drive signal CNTEN<0/1> becomes the low level, and the count operation in the counter circuit 211 ends. That is, the time T4 is the end time of the exposure period.

At the time T4, the count value of the counter circuit 211 of the zeroth row is “12′b1000_1100_1110”. Therefore, the count value of the bit output unit 211a which is the upper six bits of the counter circuit 211 is “6′b10_0011”, and the count value of the bit output unit 211b which is the lower six bits of the counter circuit 211 is “6′b00_1110”. In the notations of these count values, “12′b” and “6′b” indicate that the number of bits of the count value is 12 bits and six bits, respectively, and “1000_1100_1110” and the like indicate each bit value of the count value by a 4-bit interval.

Since the value of the control signal output from the illuminance determination circuit 230 of the zeroth row is “1”, the selector 240 of the zeroth row selects the count value of the bit output unit 211a. The pixel output circuit 250 of the zeroth row expands the 6-bit data output from the selector 240 to 12 bits and inputs the data to the selector 251. At this time, the 6-bit data output from the selector 240 is stored in the lower six bits of the expanded 12-bit data. Therefore, the count value after expansion becomes “12′b0000_0010_0011”. In the high frame rate mode, the selector 251 of the zeroth row outputs the expanded count value to the selection circuit 212.

At the time T4, the count value of the counter circuit 211 of the first row is “12′b0000_0010_1010”. Therefore, the count value of the bit output unit 211a which is the upper six bits of the counter circuit 211 is “6′b00_0000”, and the count value of the bit output unit 211b which is the lower six bits of the counter circuit 211 is “6′b10_1010”.

Since the value of the control signal output from the illuminance determination circuit 230 of the first row is “0”, the selector 240 of the first row selects the count value of the bit output unit 211b. The pixel output circuit 250 of the first row expands the 6-bit data output from the selector 240 to 12 bits and inputs the data to the selector 251. At this time, the 6-bit data output from the selector 240 is stored in the upper six bits of the expanded 12-bit data. Therefore, the count value after expansion becomes “12′b1010_1000_0000”. In the high frame rate mode, the selector 251 of the first row outputs the expanded count value to the selection circuit 212.

At time T5, the control pulse P_SEL<0/1> becomes the high level, and at time T6, the control pulse P_SEL<0/1> becomes the low level. By this operation, the reading of the zeroth row and the first row is performed in a period from the time T5 to the time T6.

The selection circuit 212 of the zeroth row connects the signal lines of the lower six bits, which are valid data of the count value “12′b0000_0010_0011” output from the selector 251, to the signal lines of the zeroth bit to the fifth bit of the pixel output signal line 113, respectively. In addition, the selection circuit 212 of the zeroth row connects the signal line transmitting the control signal of the value “1” output from the illuminance determination circuit 230 to the signal line of the twelfth bit of the pixel output signal line 113.

The selection circuit 212 of the first row connects the signal lines of the upper six bits, which are valid data of the count value “12′b1010_1000_0000” output from the selector 251, to the signal lines of the sixth bit to the eleventh bit of the pixel output signal line 113, respectively. The selection circuit 212 of the first row connects the signal line for transmitting the control signal of the value “0” output from the illuminance determination circuit 230 to the signal line of the thirteenth bit of the pixel output signal line 113.

Therefore, in the period from the time T5 to the time T6, a 14-bit value “14′b01_1010_1010_0011” indicating the count value of the zeroth row, the count value of the first row, and the attribute values is output to the pixel output signal line 113. Here, the upper six bits of the count value of the counter circuit 211 of the zeroth row are extracted and output, and the lower six bits of the count value of the counter circuit 211 of the first row are extracted and output.

At time T7, the first frame period ends. That is, a period from the time T0 to the time T7 is the first frame period. Then, a second frame period starts at the time T7.

After the time T7, the control pulse P_RES<0/1> becomes the high level, and thereafter, at time T8, the control pulse P_RES<0/1> becomes the low level. As a result, the count value held in the counter circuit 211 is reset to “0”. Therefore, the count values output from the bit output units 211a and 211b are also reset to “0”. The value of the control signal output from the illuminance determination circuit 230 is also reset to “0”.

At time T9, the drive signal CNTEN<0/1> becomes the high level, and the count operation in the counter circuit 211 starts. That is, the time T9 is the start time of an exposure period. At the time T9, the count value of the bit output unit 211b corresponding to the lower six bits of the counter circuit 211 starts to increase.

At time T10, a value is carried to the LSB of the upper six bits of the counter circuit 211 of the first row. As a result, the count value of the bit output unit 211a corresponding to the upper six bits of the counter circuit 211 of the first row starts to increase. Further, at the time T10, since one of the upper six bits of the counter circuit 211 of the first row becomes “1”, the value of the control signal output from the illuminance determination circuit 230 of the first row also becomes “1”.

At time T11, the drive signal CNTEN<0/1> becomes the low level, and the count operation in the counter circuit 211 ends. That is, the time T11 is the end time of the exposure period.

At the time T11, the count value of the counter circuit 211 of the zeroth row is “12′b0000_0011_1000”. Therefore, the count value of the bit output unit 211a which is the upper six bits of the counter circuit 211 is “6′b00_0000”, and the count value of the bit output unit 211b which is the lower six bits of the counter circuit 211 is “6′b11_1000”.

Since the value of the control signal output from the illuminance determination circuit 230 of the zeroth row is “0”, the selector 240 of the zeroth row selects the count value of the bit output unit 211b. The pixel output circuit 250 of the zeroth row expands the 6-bit data output from the selector 240 to 12 bits and inputs the data to the selector 251. At this time, the 6-bit data output from the selector 240 is stored in the lower six bits of the expanded 12-bit data. Therefore, the count value after expansion becomes “12′b0000_0011_1000”. In the high frame rate mode, the selector 251 of the zeroth row outputs the expanded count value to the selection circuit 212.

At the time T11, the count value of the counter circuit 211 of the first row is “12′b0110_0110_0110”. Therefore, the count value of the bit output unit 211a which is the upper six bits of the counter circuit 211 is “6′b01_1001”, and the count value of the bit output unit 211b which is the lower six bits of the counter circuit 211 is “6′b10_0110”.

Since the value of the control signal output from the illuminance determination circuit 230 of the first row is “1”, the selector 240 of the first row selects the count value of the bit output unit 211a. The pixel output circuit 250 of the first row expands the 6-bit data output from the selector 240 to 12 bits and inputs the data to the selector 251. At this time, the 6-bit data output from the selector 240 is stored in the upper six bits of the expanded 12-bit data. Therefore, the count value after expansion becomes “12′b0110_0100_0000”. In the high frame rate mode, the selector 251 of the first row outputs the expanded count value to the selection circuit 212.

At time T12, the control pulse P_SEL<0/1> becomes the high level, and at time T13, the control pulse P_SEL<0/1> becomes the low level. By this operation, reading of the zeroth row and the first row is performed in a period from the time T12 to the time T13.

The selection circuit 212 of the zeroth row connects the signal lines of the lower six bits, which are valid data of the count value “12′b0000_0011_1000” output from the selector 251, to the signal lines of the zeroth bit to the fifth bit of the pixel output signal line 113, respectively. In addition, the selection circuit 212 of the zeroth row connects the signal line transmitting the control signal of the value “0” output from the illuminance determination circuit 230 to the signal line of the twelfth bit of the pixel output signal line 113.

The selection circuit 212 of the first row connects the signal lines of the upper six bits, which are valid data in the count value “12′b0110_0100_0000” output from the selector 251, to the signal lines of the sixth bit to the eleventh bit of the pixel output signal line 113, respectively. In addition, the selection circuit 212 of the first row connects the signal line transmitting the control signal of the value “1” output from the illuminance determination circuit 230 to the signal line of the thirteenth bit of the pixel output signal line 113.

Therefore, in the period from the time T12 to the time T13, a 14-bit value “14′b10_0110_0111_1000” indicating the count value of the zeroth row, the count value of the first row, and the attribute values is output to the pixel output signal line 113. Here, the lower six bits of the count value of the counter circuit 211 of the zeroth row are extracted and output, and the upper six bits of the count value of the counter circuit 211 of the first row are extracted and output.

At time T14, the second frame period ends. That is, a period from the time T7 to the time T14 is the second frame period. Description of subsequent operations is omitted.

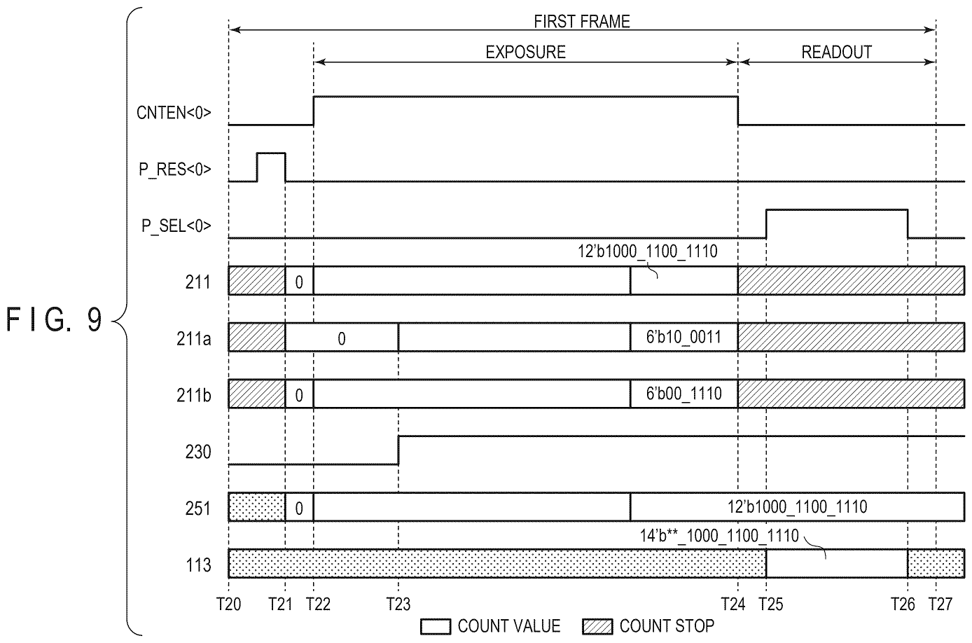

FIG. 9 is a timing chart illustrating an operation of the pixel signal processing unit 103 in the non-high frame rate mode according to the present embodiment. FIG. 9 illustrates a temporal change of the drive signal CNTEN<0> of the zeroth row and temporal changes of the control pulses P_RES<0> and P_SEL<0>. However, in the non-high frame rate mode, there is no difference in operation between the even-numbered rows and the odd-numbered rows, and the same readout is performed for each row. Hereinafter, differences from the high frame rate mode will be described.

Since operations from time T20 to time T24 are the same as the operations of the zeroth row from the time T0 to the time T4 in FIG. 8, the description thereof will be omitted. At the time T24, the count value of the counter circuit 211 of the zeroth row is “12′b1000_1100_1110”. In the non-high frame rate mode, the selector 251 outputs the count value to the selection circuit 212. That is, in the non-high frame rate mode, the count value of the counter circuit 211 is directly output to the selection circuit 212 regardless of the determination result of the illuminance determination circuit 230.

At time T25, the control pulse P_SEL<0> becomes the high level, and at time T26, the control pulse P_SEL<0> becomes the low level. By this operation, reading of the zeroth row is performed in a period from the time T25 to the time T26.

The selection circuit 212 of the zeroth row connects the signal lines for transmitting the count value “12′b1000_1100_1110” output from the selector 251 to the signal lines of the zeroth bit to the eleventh bit of the pixel output signal line 113, respectively. The twelfth bit and the thirteenth bit of the pixel output signal line 113 are don't care bits.

Therefore, in the period from the time T25 to the time T26, the 14-bit value “14′b**_1000_1100_1110” indicating the count value of the zeroth row is output to the pixel output signal line 113. The symbol “*” represents a don't care bit. At time T27, the first frame period ends.

In the present embodiment, the illuminance determination circuit 230 determines the illuminance, and the selector 240 selects the upper six bits or the lower six bits from the count value of 12 bits according to the determination result of the illuminance, and outputs 6-bit data. As a result, a signal of bits in a range including valid information according to illuminance is output. Therefore, according to the present embodiment, a photoelectric conversion device capable of outputting a more appropriate signal according to illuminance is provided.

In addition, in the present embodiment, in the high frame rate mode, data of the even-numbered row is read to the zeroth bit to the fifth bit of the pixel output signal line 113, and data of the odd-numbered row is read to the sixth bit to the eleventh bit of the pixel output signal line 113. That is, the pixel output signal line 113 is shared by the pixel signal processing units 103 of the even-numbered row and the odd-numbered row adjacent to each other. As a result, since the count values of two rows can be read out at a time, the readout time becomes one half as compared with the case of the non-high frame rate mode in which the count values are read out row by row, and the readout speed is doubled.

Although the counter circuit 211 is mainly a 12-bit counter in the present embodiment, the number of bits of the counter circuit 211 can be appropriately changed. For example, the number of bits of data held by the counter circuit 211 (12 bits) may be replaced with N bits (N is an integer equal to or greater than two). In addition, the number of bits of data output from each of the bit output units 211a and 211b (six bits) may be replaced with M bits (M is an integer equal to or greater than one and less than N). Further, as in the specific example of the present embodiment, typically, N equals to 2M. The pixel output signal line 113 may include (N+2) signal lines. The configuration and operation of the present embodiment are generalized by the above-described replacement.

### Second Embodiment

In the present embodiment, modified examples of the configuration of the pixel signal processing unit 103 and the pixel output signal line 113, the readout method, and the like will be described. In the present embodiment, description of elements common to those of the first embodiment may be omitted or simplified.

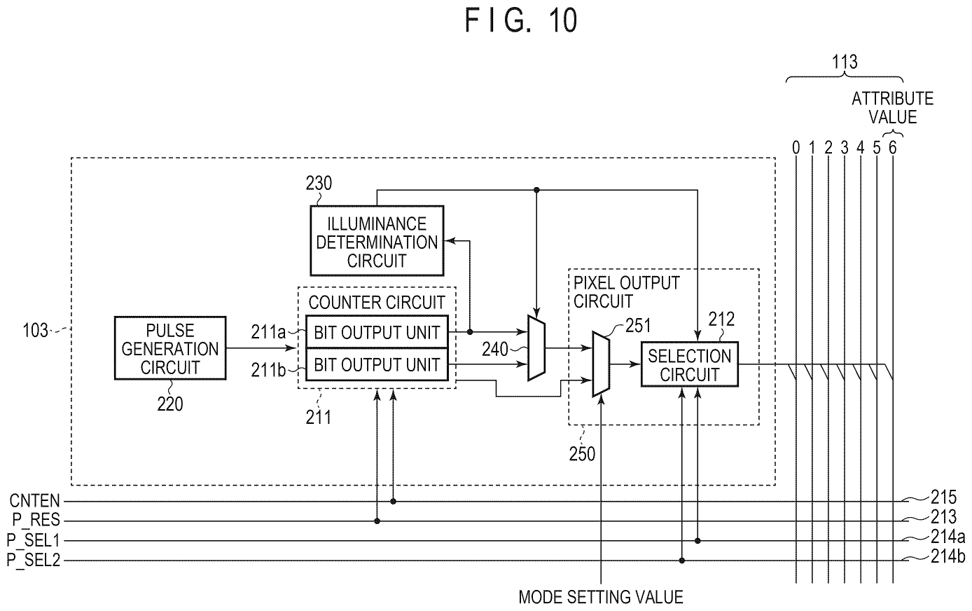

FIG. 10 is a diagram illustrating a configuration example of the pixel signal processing unit 103 according to the present embodiment. The present embodiment is different from the first embodiment illustrated in FIG. 6 in that there is no difference in operation between even-numbered rows and odd-numbered rows. In the present embodiment, the pixel output signal line 113 includes seven signal lines, and the signal line of the sixth bit among the seven signal lines transmits the attribute value.

In the present embodiment, two types of control pulses P_SEL1 and P_SEL2 are supplied to the selection circuit 212. The control pulse P_SEL1 is supplied from the control signal generation unit 115 to the selection circuit 212 via the vertical scanning circuit 110 and a driving line 214a. The control pulse P_SEL2 is supplied from the control signal generation unit 115 to the selection circuit 212 via the vertical scanning circuit 110 and a driving line 214b.

The pixel output circuit 250 expands the 6-bit data output from the selector 240 to 12-bit data by storing the 6-bit data in the upper six bits, and inputs the 12-bit data to the selector 251. Therefore, valid data is stored in the upper six bits of the expanded 12-bit data.

When the row is selected by the control pulse P_SEL1, the selection circuit 212 connects the signal lines of the upper six bits of the 12-bit data output from the selector 251 to the signal lines of the zeroth bit to the fifth bit of the pixel output signal line 113, respectively. When the row is selected by the control pulse P_SEL2, the selection circuit 212 connects the signal lines of the lower six bits of the 12-bit data output from the selector 251 to the signal lines of the zeroth bit to the fifth bit of the pixel output signal line 113, respectively. In addition, in a case where the row is selected by any of the control pulse P_SEL1 and the control pulse P_SEL2, the selection circuit 212 connects the signal line transmitting the 1-bit control signal output from the illuminance determination circuit 230 to the signal line of the sixth bit of the pixel output signal line 113.

When not in the high frame rate mode, the control signal generation unit 115 alternately supplies the control pulse P_SEL1 and the control pulse P_SEL2 to the selection circuit 212. As a result, the upper six bits and the lower six bits of the 12-bit data output from the selector 251 are alternately output to the zeroth bit to the fifth bit of the pixel output signal line 113.

When in the high frame rate mode, the control signal generation unit 115 continuously supplies the control pulse P_SEL1 to the selection circuit 212. Accordingly, the upper six bits, which are valid data of the 12-bit data output from the selector 251, are output to the zeroth bit to the fifth bit of the pixel output signal line 113, respectively. By referring to the value of the sixth bit of the pixel output signal line 113 as the attribute value, the processing circuit that performs the subsequent processing can determine whether the read data is the count value output from the bit output unit 211a or the bit output unit 211b.

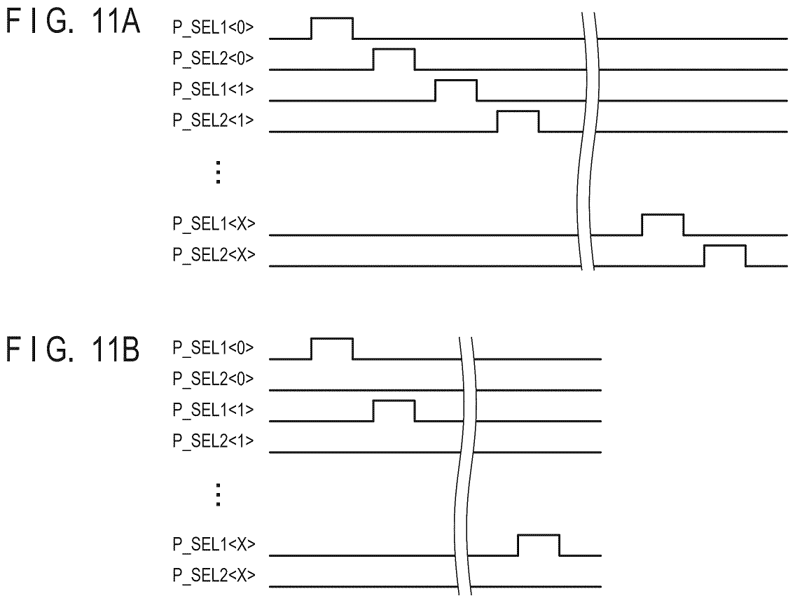

FIGS. 11A and 11B are diagrams illustrating the operation in the high frame rate mode and the non-high frame rate mode according to the present embodiment. FIGS. 11A and 11B illustrate temporal changes of control pulses P_SEL1<0> and P_SEL2<0> of the zeroth row to control pulses P_SEL1<X> and P_SEL2<X> of the X-th row.

FIG. 11A illustrates a reading operation in the non-high frame rate mode. In the non-high frame rate mode, the control signal generation unit 115 controls the selection circuit 212 so that all bits of the 12-bit data output from the selector 251 are read. Accordingly, the control pulses P_SEL1<0>, P_SEL2<0>, P_SEL1<1>, P_SEL2<1>, . . . , P_SEL1<X>, and P_SEL2<X> sequentially become the high level, whereby reading of each row is performed twice.

FIG. 11B illustrates a reading operation in the high frame rate mode. In the high frame rate mode, the control signal generation unit 115 controls the selection circuit 212 so that the upper six bits, which are valid data of the 12-bit data output from the selector 251, are read. Therefore, the control pulses P_SEL1<0>, P_SEL1<1>, . . . , and P_SEL1<X> sequentially become the high level, and the control pulses P_SEL2<0>, P_SEL2<1>, . . . , and P_SEL2<X> are maintained at the low level, so that reading of each row is performed once. As a result, as compared with the case of the non-high frame rate mode, in the high frame rate mode, the readout time becomes one half, so that the readout speed is doubled.

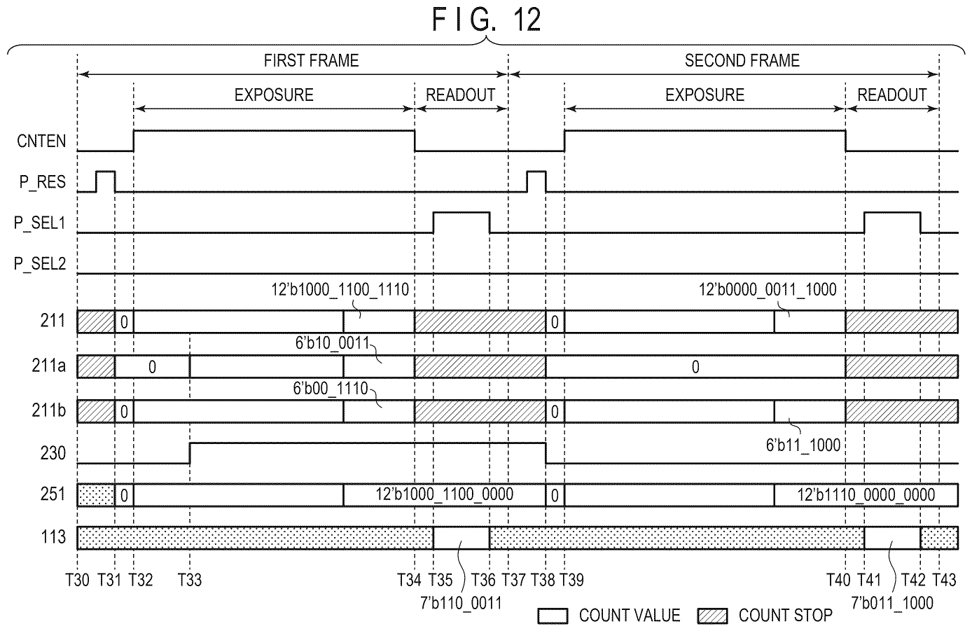

FIG. 12 is a timing chart illustrating an operation of the pixel signal processing unit 103 in the high frame rate mode according to the present embodiment. FIG. 12 illustrates temporal changes of the drive signal CNTEN and temporal changes of the control pulses P_RES, P_SEL1, and P_SEL2 in one row. In addition, FIG. 12 illustrates temporal changes of the count value in each unit of the pixel signal processing unit 103 and temporal changes of the control signal output from the illuminance determination circuit 230. As illustrated in FIG. 12, in the high frame rate mode, the control pulse P_SEL2 is always at the low level.

At time T30, a first frame period starts. After the time T30, the control pulse P_RES becomes the high level, and thereafter, at time T31, the control pulse P_RES becomes the low level. As a result, the count value held in the counter circuit 211 is reset to “0”. Therefore, the count values output from the bit output units 211a and 211b are also reset to “0”.

At time T32, the drive signal CNTEN becomes the high level, and the count operation in the counter circuit 211 starts. That is, the time T32 is the start time of an exposure period. At the time T32, the count value of the bit output unit 211b corresponding to the lower six bits of the counter circuit 211 starts to increase.

At time T33, a value is carried to the LSB of the upper six bits of the counter circuit 211. As a result, the count value of the bit output unit 211a corresponding to the upper six bits of the counter circuit 211 starts to increase. Further, at the time T33, since one of the upper six bits of the counter circuit 211 becomes “1”, the value of the control signal output from the illuminance determination circuit 230 also becomes “1”.

At time T34, the drive signal CNTEN becomes the low level, and the count operation in the counter circuit 211 ends. That is, the time T34 is the end time of the exposure period.

At the time T34, the count value of the counter circuit 211 is “12′b1000_1100_1110”. Therefore, the count value of the bit output unit 211a which is the upper six bits of the counter circuit 211 is “6′b10_0011”, and the count value of the bit output unit 211b which is the lower six bits of the counter circuit 211 is “6′b00_1110”.

Since the value of the control signal output from the illuminance determination circuit 230 is “1”, the selector 240 selects the count value of the bit output unit 211a. The pixel output circuit 250 expands the 6-bit data output from the selector 240 to 12 bits and inputs the data to the selector 251. At this time, the 6-bit data output from the selector 240 is stored in the upper six bits of the expanded 12-bit data. Therefore, the count value after expansion becomes “12′b1000_1100_0000”. In the high frame rate mode, the selector 251 outputs the expanded count value to the selection circuit 212.

At time T35, the control pulse P_SEL1 becomes the high level, and at time T36, the control pulse P_SEL1 becomes the low level. By this operation, reading is performed in a period from the time T35 to the time T36.

The selection circuit 212 connects the signal lines of the upper six bits, which are valid data of the count value “12′b1000_1100_0000” output from the selector 251, to the signal lines of the zeroth bit to the fifth bit of the pixel output signal line 113, respectively. Further, the selection circuit 212 connects the signal line for transmitting the control signal of the value “1” output from the illuminance determination circuit 230 to the signal line of the sixth bit of the pixel output signal line 113.

Therefore, in the period from the time T35 to the time T36, “7′b110_0011” indicating the upper six bits of the count value of the counter circuit 211 and the attribute value is output to the pixel output signal line 113.

At time T37, the first frame period ends. That is, a period from the time T30 to the time T37 is the first frame period. Then, the second frame period starts at the time T37.

After the time T37, the control pulse P_RES becomes the high level, and thereafter, at time T38, the control pulse P_RES becomes the low level. As a result, the count value held in the counter circuit 211 is reset to “0”. Therefore, the count values output from the bit output units 211a and 211b are also reset to “0”. The value of the control signal output from the illuminance determination circuit 230 is also reset to “0”.

At time T39, the drive signal CNTEN becomes the high level, and the count operation in the counter circuit 211 starts. That is, the time T39 is the start time of an exposure period. At the time T39, the count value of the bit output unit 211b corresponding to the lower six bits of the counter circuit 211 starts to increase.

At time T40, the drive signal CNTEN becomes the low level, and the count operation in the counter circuit 211 ends. That is, the time T40 is the end time of the exposure period.

At the time T40, the count value of the counter circuit 211 is “12′b0000_0011_1000”. Therefore, the count value of the bit output unit 211a which is the upper six bits of the counter circuit 211 is “6′b00_0000”, and the count value of the bit output unit 211b which is the lower six bits of the counter circuit 211 is “6′b11_1000”.

Since the value of the control signal output from the illuminance determination circuit 230 is “0”, the selector 240 selects the count value of the bit output unit 211b. The pixel output circuit 250 expands the 6-bit data output from the selector 240 to 12 bits and inputs the data to the selector 251. At this time, the 6-bit data output from the selector 240 is stored in the upper six bits of the expanded 12-bit data. Therefore, the count value after expansion becomes “12′b1110_0000_0000”. In the high frame rate mode, the selector 251 outputs the expanded count value to the selection circuit 212.

At time T41, the control pulse P_SEL1 becomes the high level, and at time T42, the control pulse P_SEL1 becomes the low level. By this operation, reading is performed in a period from the time T41 to the time T42.

The selection circuit 212 connects the signal lines of the upper six bits, which are valid data of the count value “12′b1110_0000_0000” output from the selector 251, to the signal lines of the zeroth bit to the fifth bit of the pixel output signal line 113, respectively. The selection circuit 212 connects the signal line for transmitting the control signal of the value “0” output from the illuminance determination circuit 230 to the signal line of the sixth bit of the pixel output signal line 113.

Therefore, in the period from the time T41 to the time T42, “7′b011_1000” indicating the lower six bits of the count value of the counter circuit 211 and the attribute value is output to the pixel output signal line 113.

At time T43, the second frame period ends. That is, a period from the time T37 to the time T43 is the second frame period. Description of subsequent operations is omitted.

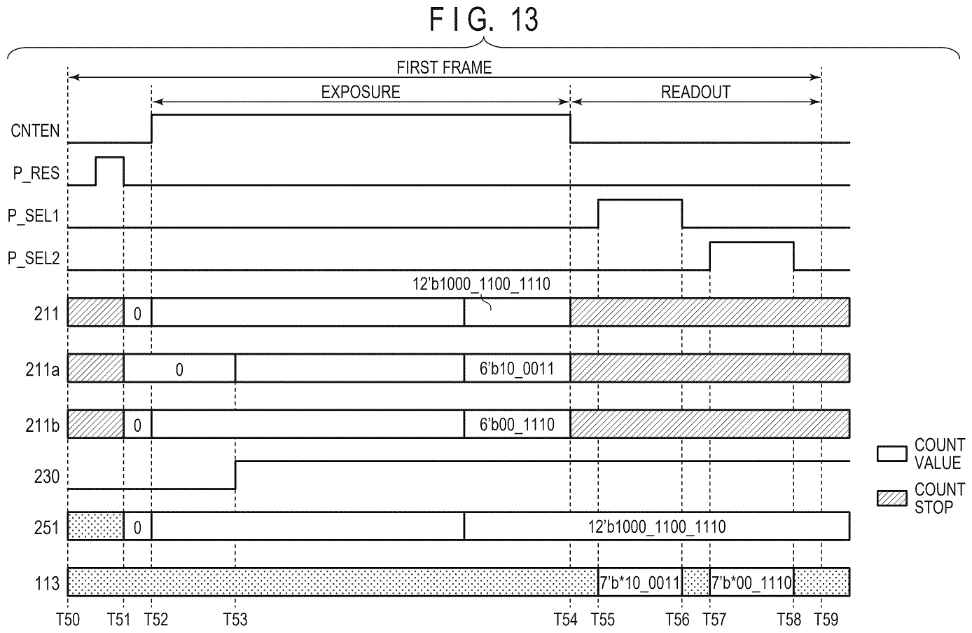

FIG. 13 is a timing chart illustrating an operation of the pixel signal processing unit 103 in the non-high frame rate mode according to the present embodiment. Hereinafter, differences from the high frame rate mode will be described.

Since operations from time T50 to time T54 are the same as the operations from the time T30 to the time T34 in FIG. 12, the description thereof will be omitted. At the time T54, the count value of the counter circuit 211 is “12′b1000_1100_1110”. In the non-high frame rate mode, the selector 251 outputs the count value to the selection circuit 212. That is, in the non-high frame rate mode, the count value of the counter circuit 211 is directly output to the selection circuit 212 regardless of the determination result of the illuminance determination circuit 230.

At time T55, the control pulse P_SEL1 becomes the high level, and at time T56, the control pulse P_SEL1 becomes the low level. By this operation, the upper six bits are read in a period from the time T55 to the time T56.

The selection circuit 212 connects the signal lines of the upper six bits of the count value “12′b1000_1100_1110” output from the selector 251 to the signal lines of the zeroth bit to the fifth bit of the pixel output signal line 113, respectively. The sixth bit of the pixel output signal line 113 is a don't care bit.

Therefore, in the period from the time T55 to the time T56, “7′b*10_0011” indicating the upper six bits of the count value of the counter circuit 211 is output to the pixel output signal line 113.

At time T57, the control pulse P_SEL2 becomes the high level, and at time T58, the control pulse P_SEL2 becomes the low level. By this operation, the lower six bits are read in a period from the time T57 to the time T58.

The selection circuit 212 connects the signal lines of the lower six bits of the count value “12′b1000_1100_1110” output from the selector 251 to the signal lines of the zeroth bit to the fifth bit of the pixel output signal line 113, respectively. The sixth bit of the pixel output signal line 113 is a don't care bit.

Therefore, in the period from the time T57 to the time T58, “7′b*00_1110” indicating the lower six bits of the count value of the counter circuit 211 is output to the pixel output signal line 113. At time T59, the first frame period ends.

Also in the present embodiment, similarly to the first embodiment, a photoelectric conversion device capable of outputting a more appropriate signal according to illuminance is provided. In addition, in the present embodiment, in the non-high frame rate mode, reading of each row is performed in a plurality of times by the control pulse P_SEL1 and the control pulse P_SEL2. On the other hand, in the high frame rate mode, reading of each row is performed one time by the control pulse P_SEL1. As a result, as compared with the case of the non-high frame rate mode, in the high frame rate mode, the readout time becomes one half, so that the readout speed is doubled.

Also in the present embodiment, the number of bits of the counter circuit 211 can be appropriately changed. For example, the number of bits of data held by the counter circuit 211 (12 bits) may be replaced with N bits (N is an integer equal to or greater than two). In addition, the number of bits of data output from each of the bit output units 211a and 211b (six bits) may be replaced with M bits (M is an integer equal to or greater than one and less than N). Further, as in the specific example of the present embodiment, typically, N equals to 2M. The pixel output signal line 113 may include (M+1) signal lines or (N/2+1) signal lines. The configuration and operation of the present embodiment are generalized by the above-described replacement.

### Third Embodiment

In the present embodiment, modified examples of the configuration of the pixel signal processing unit 103 and the pixel output signal line 113, the readout method, and the like will be described. In the present embodiment, description of elements common to the first embodiment or the second embodiment may be omitted or simplified.

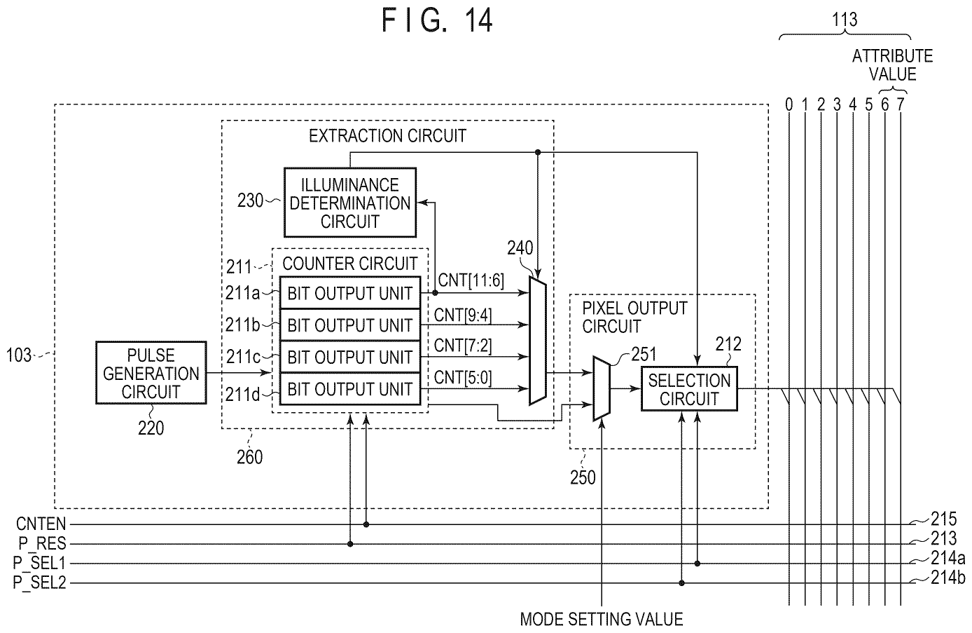

FIG. 14 is a diagram illustrating a configuration example of the pixel signal processing unit 103 according to the present embodiment. In the present embodiment, the counter circuit 211 includes four bit output units 211a, 211b, 211c, and 211d. In the present embodiment, the pixel output signal line 113 is constituted by eight signal lines, and a signal line of the seventh bit for transmitting an attribute value is added to the configuration of the second embodiment. In the present embodiment, a circuit block including the counter circuit 211, the illuminance determination circuit 230, and the selector 240 is referred to as an extraction circuit 260.

The bit output unit 211a outputs data CNT[11:6] of the upper six bits of the 12-bit data held in the counter circuit 211. Here, the two numerical values in the square brackets of “CNT[11:6]” indicate a range of bit values included in the output data of the 12-bit data. That is, the data CNT[11:6] includes bit values of the sixth bit to the eleventh bit of the 12-bit data.

In addition, the bit output unit 211b outputs data CNT[9:4] of the upper-middle six bits of the 12-bit data held in the counter circuit 211. The bit output unit 211c outputs data CNT[7:2] of the lower-middle six bits of the 12-bit data held in the counter circuit 211. The bit output unit 211d outputs data CNT[5:0] of the lower six bits of the 12-bit data held in the counter circuit 211. As described above, the counter circuit 211 can output the held 12-bit data in four ranges of the upper six bits, the upper-middle six bits, the lower-middle six bits, and the lower six bits (first range, second range, third range, and fourth range). In the present embodiment, the ranges of bits output from the four bit output units are set so as to partially overlap each other.

The illuminance determination circuit 230 receives the data CNT[11:6] of the upper six bits output from the bit output unit 211a. The illuminance determination circuit 230 outputs a control signal indicating illuminance to the selector 240 and the selection circuit 212 based on the data CNT[11:6]. The selector 240 selects one of the data CNT[11:6], CNT[9:4], CNT[7:2], and CNT[5:0] according to the control signal input from the illuminance determination circuit 230, and outputs the selected data to the pixel output circuit 250.

In the present embodiment, a 2-bit control signal is input to the selection circuit 212 from the illuminance determination circuit 230. In the case where the row is selected by any of the control pulses P_SEL1 and P_SEL2, the selection circuit 212 connects the signal lines transmitting the 2-bit control signal output from the illuminance determination circuit 230 to the signal lines of the sixth bit and the seventh bit of the pixel output signal line 113. Other operations of the pixel output circuit 250 are the same as those of the second embodiment. By referring to the values of the sixth bit and the seventh bit of the pixel output signal line 113 as attribute values, the processing circuit that performs the subsequent processing can determine which of the bit output unit 211a, 211b, 211c, and 211d has output the read data.

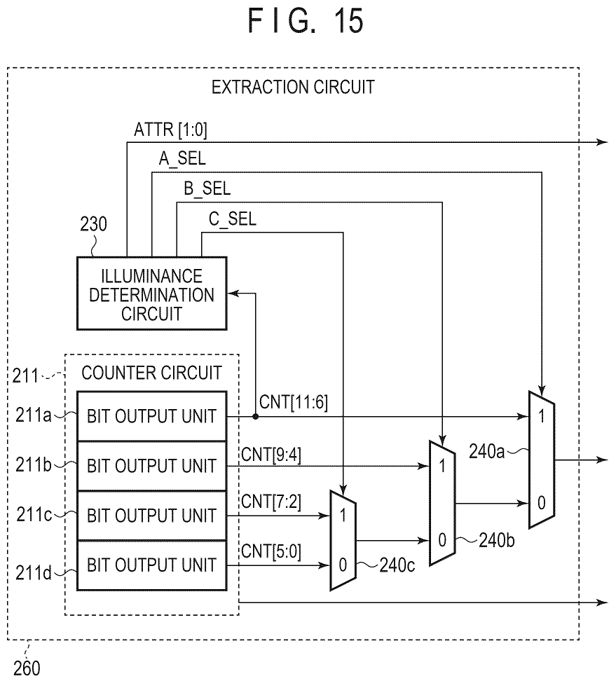

FIG. 15 is a diagram illustrating a configuration example of the extraction circuit 260 according to the present embodiment. FIG. 15 more specifically illustrates the configuration of the extraction circuit 260 in FIG. 14. Selectors 240a, 240b, and 240c of FIG. 15 illustrates the constituent of the selector 240 of FIG. 14.

FIG. 15 also illustrates four types of control signals ATTR[1:0], A_SEL, B_SEL, and C_SEL output from the illuminance determination circuit 230. The illuminance determination circuit 230 outputs the control signal A_SEL to the selector 240a, outputs the control signal B_SEL to the selector 240b, and outputs the control signal C_SEL to the selector 240c. Each of the control signals A_SEL, B_SEL, and C_SEL may be a 1-bit signal. The illuminance determination circuit 230 outputs the control signal ATTR[1:0] to the selection circuit 212. The control signal ATTR[1:0] is a 2-bit signal constituted by a control signal ATTR[1] of the first bit and a control signal ATTR[0] of the zeroth bit.

The data CNT[7:2] and CNT[5:0] are input to the selector 240c. The selector 240c outputs the data CNT[7:2] when the control signal C_SEL is “1”, and outputs the data CNT[5:0] when the control signal C_SEL is “0”.

The data CNT[9:4] and the output signal of the selector 240c are input to the selector 240b. The selector 240b outputs the data CNT[9:4] when the control signal B_SEL is “1”, and outputs the output signal of the selector 240c when the control signal B_SEL is “0”.

The data CNT[11:6] and the output signal of the selector 240b are input to the selector 240a. The selector 240a outputs the data CNT[11:6] when the control signal A_SEL is “1”, and outputs the output signal of the selector 240b when the control signal A_SEL is “0”.

The illuminance determination circuit 230 calculates the values of the control signals A_SEL, B_SEL, and C_SEL by the following Expressions (1) to (3) using the values of the bits constituting the data CNT[11:6] output from the bit output unit 211a. Note that “|” indicates the bitwise logical sum.

$$A\_SEL = CNT [ 11 ] \vert CNT [ 10 ] \qquad ( 1 )$$

$$B\_SEL = CNT [ 9 ] \vert CNT [ 8 ] \qquad ( 2 )$$

$$C\_SEL = CNT [ 7 ] \vert CNT [ 6 ] \qquad ( 3 )$$

In addition, the illuminance determination circuit 230 calculates the value of the control signal ATTR[1:0] by the following Expressions (4) and (5) using the values of the control signals A_SEL, B_SEL, and C_SEL. Here, “~” indicates the bit inversion, and “&” indicates the bitwise logical product.

$$ATTR [ 1 ] = A\_SEL \vert B\_SEL \qquad ( 4 )$$

$$ATTR [ 0 ] = A\_SEL \vert ( \sim B\_SEL \& C\_SEL ) \qquad ( 5 )$$

For example, when the count value of the counter circuit 211 is “12′b0000_0010_1011”, all of the control signals A_SEL, B_SEL, and C_SEL are “0”. In this case, the 6-bit data output from the selector 240a is “6′b10_1011” corresponding to the data CNT[5:0] output from the bit output unit 211d. In addition, the control signal ATTR[1:0] is “2′b00”.

In another example, when the count value of the counter circuit 211 is “12′b0000_1010_1111”, the control signals A_SEL and B_SEL are both “0” and the control signal C_SEL is “1”. In this case, the 6-bit data output from the selector 240a is “6′b10_1011” corresponding to the data CNT[7:2] output from the bit output unit 211c. In addition, the control signal ATTR[1:0] is “2′b01”.

In another example, when the count value of the counter circuit 211 is “12′b0010_1011_1111”, the control signal A_SEL is “0”, and the control signals B_SEL and C_SEL are both “1”. In this case, the count value output from the selector 240a is “6′b10_1011” corresponding to the data CNT[9:4] output from the bit output unit 211b. In addition, the control signal ATTR[1:0] is “2′b10”.

In another example, when the count value of the counter circuit 211 is “12′b1010_1111_1111”, all of the control signals A_SEL, B_SEL, and C_SEL are “1”. In this case, the count value output from the selector 240a is “6′b10_1011” corresponding to the data CNT[11:6] output from the bit output unit 211a. In addition, the control signal ATTR[1:0] is “2′b11”.

That is, when the count value reaches the upper two bits of the output data of the bit output unit 211a, the extraction circuit 260 outputs the data CNT[11:6]. Similarly, when the count value reaches the upper two bits of the output data of the bit output unit 211b, the extraction circuit 260 outputs the data CNT[9:4]. When the count value reaches the upper two bits of the output data of the bit output unit 211c, the extraction circuit 260 outputs the data CNT[7:2]. When the count value does not reach the upper two bits of the output data of the bit output unit 211c, the extraction circuit 260 outputs the data CNT[5:0].

Also in the present embodiment, the same effect as in the second embodiment can be obtained. In addition, in the present embodiment, the bit output unit 211a, 211b, 211c, and 211d outputs data including bits of four kinds of ranges, and the range of bits included in the data to be output can be switched in four stages in accordance with the bits of which the count value has reached. Accordingly, in the present embodiment, data including more valid information can be output as compared with the configuration of the second embodiment.

Also in the present embodiment, the number of bits of the counter circuit 211 can be appropriately changed. For example, the number of bits of data held by the counter circuit 211 (12 bits) may be replaced with N bits (N is an integer equal to or greater than two). In addition, the number of bits of data output from each of the bit output units 211a, 211b, 211c, and 211d (six bits) may be replaced with M bits (M is an integer equal to or greater than one and less than N). Further, as in the specific example of the present embodiment, typically, N equals to 2M. The pixel output signal line 113 may include (M+2) signal lines or (N/2+2) signal lines. The configuration and operation of the present embodiment are generalized by the above-described replacement.

### Fourth Embodiment

In the present embodiment, modified examples of the configuration of the pixel signal processing unit 103 and the pixel output signal line 113, the readout method, and the like will be described. In the present embodiment, description of elements common to the first embodiment to third embodiment may be omitted or simplified.

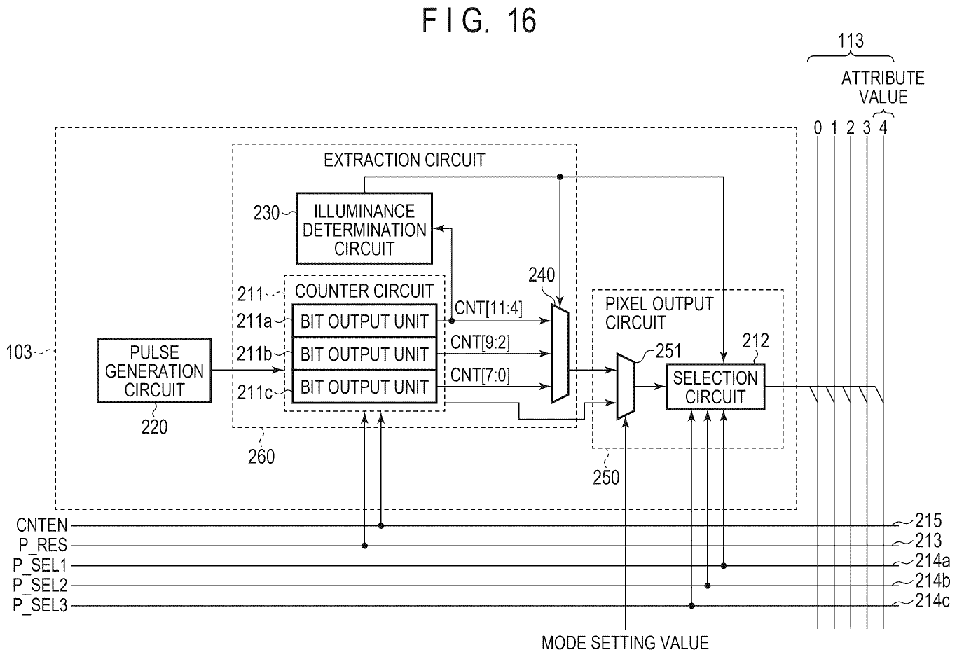

FIG. 16 is a diagram illustrating a configuration example of the pixel signal processing unit 103 according to the present embodiment. In the present embodiment, the counter circuit 211 includes three bit output units 211a, 211b, and 211c. Further, in the present embodiment, the pixel output signal line 113 is constituted by five signal lines, and a signal line of the fourth bit among the five signal lines transmits the attribute value.

In the present embodiment, in addition to the control pulses P_SEL1 and P_SEL2, a control pulse P_SEL3 is further supplied to the selection circuit 212. The control pulse P_SEL3 is supplied from the control signal generation unit 115 to the selection circuit 212 via the vertical scanning circuit 110 and the driving line 214c.

The bit output unit 211a outputs data CNT[11:4] of the upper eight bits of the 12-bit data held in the counter circuit 211. The bit output unit 211b outputs data CNT[9:2] of the middle 8 bits of the 12-bit data held in the counter circuit 211. The bit output unit 211c outputs data CNT[7:0] of the lower eight bits of the 12-bit data held in the counter circuit 211.

The illuminance determination circuit 230 receives the data CNT[11:4] of the upper eight bits output from the bit output unit 211a. The illuminance determination circuit 230 outputs a control signal indicating illuminance to the selector 240 and the selection circuit 212 based on the data CNT[11:4]. The selector 240 selects one of the data CNT[11:4], CNT[9:2], and CNT[7:0] according to the control signal input from the illuminance determination circuit 230, and outputs the selected data to the pixel output circuit 250.

The pixel output circuit 250 expands the 8-bit data output from the selector 240 to 12-bit data by storing the 8-bit data in the upper eight bits, and inputs the 12-bit data to the selector 251. Therefore, valid data is stored in the upper eight bits of the expanded 12-bit data.

When the row is selected by the control pulse P_SEL1, the selection circuit 212 connects the signal lines of the upper four bits of the 12-bit data output from the selector 251 to the signal lines of the zeroth bit to the third bit of the pixel output signal line 113, respectively. In addition, at this time, the selection circuit 212 connects the signal line of the upper one bit of the 2-bit control signal output from the illuminance determination circuit 230 to the signal line of the fourth bit of the pixel output signal line 113.

When the row is selected by the control pulse P_SEL2, the selection circuit 212 connects the signal lines of the middle four bits of the 12-bit data output from the selector 251 to the signal lines of the zeroth bit to the third bit of the pixel output signal line 113, respectively. In addition, at this time, the selection circuit 212 connects the signal line of the lower one bit of the 2-bit control signal output from the illuminance determination circuit 230 to the signal line of the fourth bit of the pixel output signal line 113.

When the row is selected by the control pulse P_SEL3, the selection circuit 212 connects the signal lines of the lower four bits of the 12-bit data output from the selector 251 to the signal lines of the zeroth bit to the third bit of the pixel output signal line 113, respectively.

When not in the high frame rate mode, the control signal generation unit 115 cyclically supplies the control pulse P_SEL1, the control pulse P_SEL2, and the control pulse P_SEL3 to the selection circuit 212. Accordingly, the upper four bits, the middle four bits, and the lower four bits of the 12-bit data output from the selector 251 are cyclically output to the zeroth bit to the third bit of the pixel output signal line 113.

When in the high frame rate mode, the control signal generation unit 115 alternately supplies the control pulse P_SEL1 and the control pulse P_SEL2 to the selection circuit 212. Accordingly, the upper four bits and the middle four bits, which are the valid data of the 12-bit data output from the selector 251, are output to the zeroth bit to the third bit of the pixel output signal line 113. By referring to the value of the fourth bit of the pixel output signal line 113 as the attribute value, the processing circuit that performs the subsequent processing can determine whether the read data is the count value output from the bit output unit 211a or the bit output unit 211b.

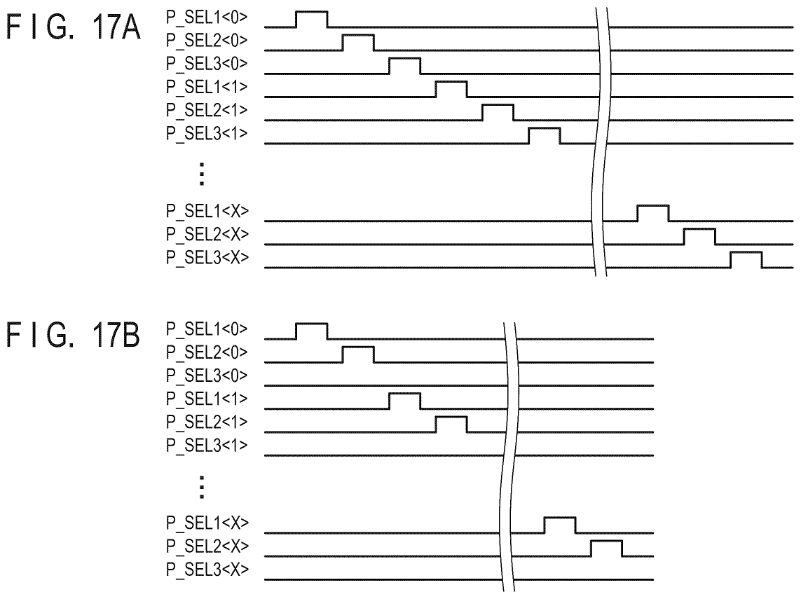

FIGS. 17A and 17B are diagrams illustrating the operation in the high frame rate mode and the non-high frame rate mode according to the present embodiment. FIGS. 17A and 17B illustrate temporal changes of control pulses P_SEL1<0>, P_SEL2<0>, and P_SEL3<0> of the zeroth row to control pulses P_SEL1<X>, P_SEL2<X>, and P_SEL3<X> of the X-th row.

FIG. 17A illustrates a reading operation in the non-high frame rate mode. In the non-high frame rate mode, the control signal generation unit 115 controls the selection circuit 212 so that all bits of the 12-bit data output from the selector 251 are read. Accordingly, the control pulses P_SEL1<0>, P_SEL2<0>, P_SEL3<0>, . . . , P_SEL1<X>, P_SEL2<X>, and P_SEL3<X> are sequentially become the high level, whereby reading of each row is performed three times.

FIG. 17B illustrates a reading operation in the high frame rate mode. In the high frame rate mode, the control signal generation unit 115 controls the selection circuit 212 so that the upper eight bits, which are valid data of the 12-bit data output from the selector 251, are read. Therefore, the control pulses P_SEL1<0>, P_SEL2<0>, P_SEL1<1>, P_SEL2<1>, . . . , P_SEL1<X>, and P_SEL2<X> sequentially becomes the high level. The control pulses P_SEL3<0>, P_SEL3<1>, . . . , and P_SEL3<X> are maintained at the low level. Therefore, reading of each row is performed twice. As a result, as compared with the case of the non-high frame rate mode, in the high frame rate mode, the readout time becomes two-thirds, so that a readout speed is 1.5 times faster than in non-high frame rate mode.

In the present embodiment, in the non-high frame rate mode, the count value of 12 bits is read three times by four bits, and in the high frame rate mode, the count value of eight bits out of 12 bits is read two times by four bits. However, in the high frame rate mode, four bits out of 12 bits may be read out once. Thus, the number of bits read at one time, the total number of bits to be read, the number of times of reading, and the like are not limited to the illustrated example.

For example, in the non-high frame rate mode, the count value of 12 bits may be read six times by two bits, and in the high frame rate mode, the count value of 10 bits out of 12 bits may be read five times by two bits. In this case, each bit output unit may output 10-bit data. Alternatively, for example, in the non-high frame rate mode, the count value of 12 bits may be read in six times by two bits, and in the high frame rate mode, the count value of four bits out of 12 bits may be read in two times by two bits. In this case, each bit output unit may output 4-bit data.

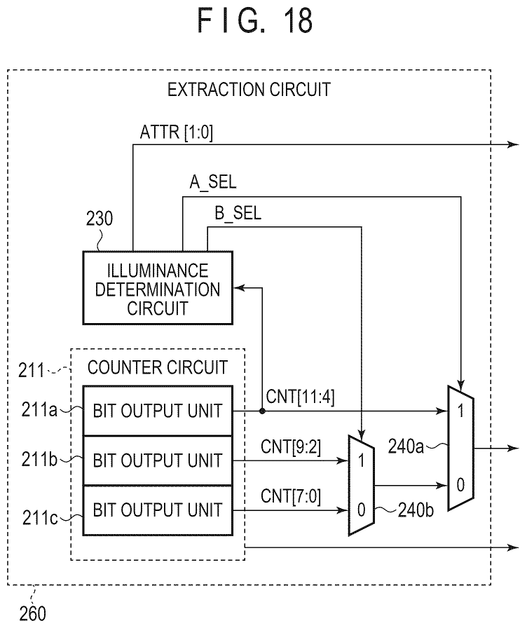

FIG. 18 is a diagram illustrating a configuration example of the extraction circuit 260 according to the present embodiment. FIG. 18 more specifically illustrates the configuration of the extraction circuit 260 in FIG. 16. Selectors 240a and 240b of FIG. 18 illustrates the constituent of the selector 240 of FIG. 16.

FIG. 18 illustrates three types of control signals ATTR[1:0], A_SEL, and B_SEL output from the illuminance determination circuit 230. The illuminance determination circuit 230 outputs the control signal A_SEL to the selector 240a, and outputs the control signal B_SEL to the selector 240b. The illuminance determination circuit 230 outputs the control signal ATTR[1:0] to the selection circuit 212. The control signal ATTR[1:0] is a 2-bit signal, and each of the control signals A_SEL and B_SEL is a 1-bit signal.

The data CNT[9:2] and the data CNT[7:0] are input to the selector 240b. The selector 240b outputs the data CNT[9:2] when the control signal B_SEL is “1”, and outputs the data CNT[7:0] when the control signal B_SEL is “0”.

The data CNT[11:4] and the output signal of the selector 240b are input to the selector 240a. The selector 240a outputs the data CNT[11:4] when the control signal A_SEL is “1”, and outputs the output signal of the selector 240b when the control signal A_SEL is “0”.

The illuminance determination circuit 230 calculates the values of the control signals A_SEL and B_SEL by the following Expressions (6) and (7) using the values of the upper four bits of the data CNT[11:4] output from the bit output unit 211a.

$$A\_SEL = CNT [ 11 ] \vert CNT [ 10 ] \qquad ( 6 )$$

$$B\_SEL = CNT [ 9 ] \vert CNT [ 8 ] \qquad ( 7 )$$

In addition, the illuminance determination circuit 230 calculates the value of the control signal ATTR[1:0] by the following Expressions (8) and (9) using the values of the control signals A_SEL and B_SEL.

$$ATTR [ 1 ] = A\_SEL \qquad ( 8 )$$

$$ATTR [ 0 ] = B\_SEL \qquad ( 9 )$$

For example, when the count value of the counter circuit 211 is “12′b0000_0010_1011”, the control signals A_SEL and B_SEL are both “0”. In this case, the 8-bit data output from the selector 240a is “8′b0010_1011” corresponding to the data CNT[7:0] output from the bit output unit 211c. In addition, the control signal ATTR[1:0] is “2′b00”.

In another example, when the count value of the counter circuit 211 is “12′b0000_1010_1111”, the control signals A_SEL and B_SEL are both “0”. In this case, the 8-bit data output from the selector 240a is “8′b1010_1111” corresponding to the data CNT[7:0] output from the bit output unit 211c. In addition, the control signal ATTR[1:0] is “2′b00”.

In another example, when the count value of the counter circuit 211 is “12′b0010_1011_1111”, the control signal A_SEL is “0” and the control signal B_SEL is “1”. In this case, the 8-bit data output from the selector 240a is “8′b1010_1111” corresponding to the data CNT[9:2] output from the bit output unit 211b. In addition, the control signal ATTR[1:0] is “2′b01”.

In another example, when the count value of the counter circuit 211 is “12′b1010_1111_1111”, the control signals A_SEL and B_SEL are both “1”. In this case, the 8-bit data output from the selector 240a is “8′b1010_1111” corresponding to the data CNT[11:4] output from the bit output unit 211a. In addition, the control signal ATTR[1:0] is “2′b11”.

That is, when the count value reaches the upper two bits of the output data of the bit output unit 211a, the extraction circuit 260 outputs the data CNT[11:4]. Similarly, when the count value reaches the upper two bits of the output data of the bit output unit 211b, the extraction circuit 260 outputs the data CNT[9:2]. When the count value does not reach the upper two bits of the output data of the bit output unit 211b, the extraction circuit 260 outputs the data CNT[7:0].

When the extraction circuit 260 outputs the data CNT[11:4], the value of the control signal ATTR[1:0] may be either “2′b11” or “2′b10”. When the upper one bit of the control signal ATTR[1:0] is “1”, the processing circuit that performs the subsequent processing can determine that the read data is output from the bit output unit 211a. That is, when the upper one bit of the control signal ATTR[1:0] is “1”, the lower one bit of the control signal ATTR[1:0] is a don't care bit.

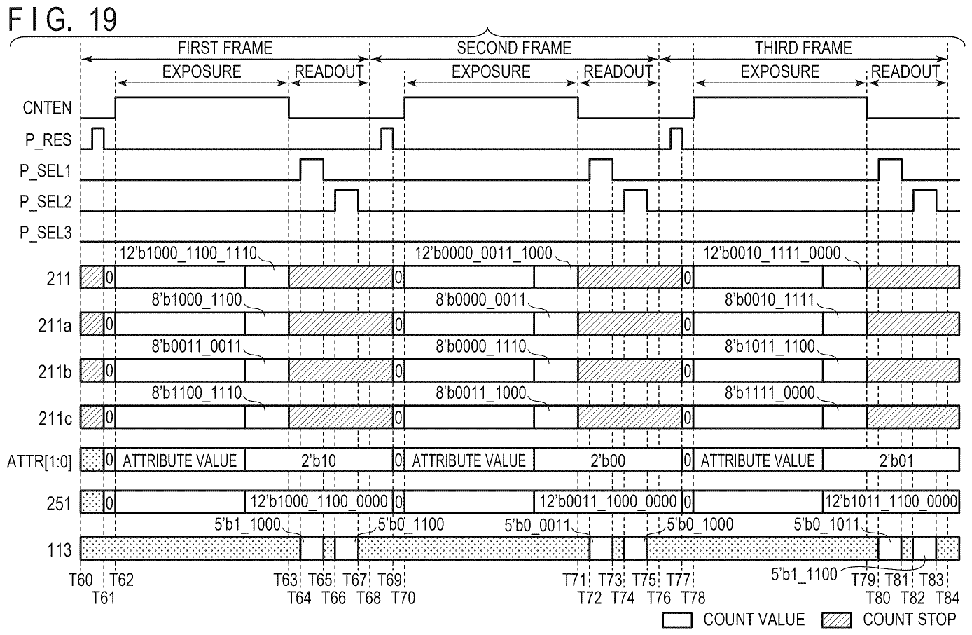

FIG. 19 is a timing chart illustrating an operation of the pixel signal processing unit 103 in the high frame rate mode according to the present embodiment. FIG. 19 illustrates temporal changes of the drive signal CNTEN and temporal changes of the control pulses P_RES, P_SEL1, P_SEL2, and P_SEL3 in one row. In addition, FIG. 19 illustrates temporal changes of the count value in each unit of the pixel signal processing unit 103 and temporal changes of the control signal ATTR[1:0] output from the illuminance determination circuit 230. As illustrated in FIG. 19, in the high frame rate mode, the control pulse P_SEL3 is always at the low level.

At time T60, a first frame period starts. After the time T60, the control pulse P_RES becomes the high level, and thereafter, at time T61, the control pulse P_RES becomes the low level. As a result, the count value held in the counter circuit 211 is reset to “0”. Therefore, the count values output from the bit output units 211a, 211b, and 211c are also reset to “0”.

At time T62, the drive signal CNTEN becomes the high level, and the count operation in the counter circuit 211 starts. That is, the time T62 is the start time of an exposure period. At time T63, the drive signal CNTEN becomes the low level, and the count operation in the counter circuit 211 ends. That is, the time T63 is the end time of the exposure period.

At the time T63, the count value of the counter circuit 211 is “12′b1000_1100_1110”. Therefore, the count value of the bit output unit 211a which is the upper eight bits of the counter circuit 211 is “8′b1000_1100”, and the count value of the bit output unit 211b which is the middle eight bits of the counter circuit 211 is “8′b0011_0011”. The count value of the bit output unit 211c which is the lower eight bits of the counter circuit 211 is “8′b1100_1110”.

According to the Expressions (6) to (9), the control signal A_SEL is “1”, the control signal B_SEL is “0”, and the control signal ATTR[1:0] is “2′b10”. Therefore, the selector 240 selects the count value of the bit output unit 211a. The pixel output circuit 250 expands the 8-bit data output from the selector 240 to 12 bits and inputs the data to the selector 251. At this time, the 8-bit data output from the selector 240 is stored in the upper eight bits of the expanded 12-bit data. Therefore, the count value after expansion becomes “12′b1000_1100_0000”. In the high frame rate mode, the selector 251 outputs the expanded count value to the selection circuit 212.

At time T64, the control pulse P_SEL1 becomes the high level, and at time T65, the control pulse P_SEL1 becomes the low level. By this operation, reading is performed in a period from the time T64 to the time T65.

The selection circuit 212 connects the signal lines of the upper four bits, which are valid data of the count value “12′b1000_1100_0000” output from the selector 251, to the signal lines of the zeroth bit to the third bit of the pixel output signal line 113, respectively. Further, the selection circuit 212 connects the signal line of the upper one bit of the attribute value “2′b10” indicated by the control signal ATTR[1:0] output from the illuminance determination circuit 230 to the signal line of the fourth bit of the pixel output signal line 113.

Therefore, in the period from the time T64 to the time T65, “5′b1_1000” indicating the upper four bits of the count value of the counter circuit 211 and the upper one bit of the attribute value is output to the pixel output signal line 113.

At time T66, the control pulse P_SEL2 becomes the high level, and at time T67, the control pulse P_SEL2 becomes the low level. By this operation, reading is performed in a period from the time T66 to the time T67.

The selection circuit 212 connects the signal lines of the middle four bits, which are valid data of the count value “12′b1000_1100_0000” output from the selector 251, to the signal lines of the zeroth bit to the third bit of the pixel output signal line 113, respectively. The selection circuit 212 connects the signal line of the lower one bit of the attribute value “2′b10” indicated by the control signal ATTR[1:0] output from the illuminance determination circuit 230 to the signal line of the fourth bit of the pixel output signal line 113.

Therefore, in the period from the time T66 to the time T67, “5′b0_1100” indicating the middle four bits of the count value of the counter circuit 211 and the lower one bit of the attribute value is output to the pixel output signal line 113.

At time T68, the first frame period ends. That is, a period from the time T60 to the time T68 is the first frame period. Then, the second frame period starts at the time T68.

After the time T68, the control pulse P_RES becomes the high level, and thereafter, at time T69, the control pulse P_RES becomes the low level. As a result, the count value held in the counter circuit 211 is reset to “0”. Therefore, the count values output from the bit output units 211a, 211b, and 211c are also reset to “0”. The value of the control signal ATTR[1:0] output from the illuminance determination circuit 230 is also reset to “0”.

At time T70, the drive signal CNTEN becomes the high level, and the count operation in the counter circuit 211 starts. That is, the time T70 is the start time of an exposure period. At time T71, the drive signal CNTEN becomes the low level, and the count operation in the counter circuit 211 ends. That is, the time T71 is the end time of the exposure period.

At the time T71, the count value of the counter circuit 211 is “12′b0000_0011_1000”. Therefore, the count value of the bit output unit 211a which is the upper eight bits of the counter circuit 211 is “8′b0000_0011”, and the count value of the bit output unit 211b which is the middle eight bits of the counter circuit 211 is “8′b0000_1110”. The count value of the bit output unit 211c which is the lower eight bits of the counter circuit 211 is “8′b0011_1000”.

According to the Expressions (6) to (9), the control signal A_SEL is “0”, the control signal B_SEL is “0”, and the control signal ATTR[1:0] is “2′b00”. Therefore, the selector 240 selects the count value of the bit output unit 211c. The pixel output circuit 250 expands the 8-bit data output from the selector 240 to 12 bits and inputs the data to the selector 251. At this time, the 8-bit data output from the selector 240 is stored in the upper eight bits of the expanded 12-bit data. Therefore, the count value after expansion becomes “12′b0011_1000_0000”. In the high frame rate mode, the selector 251 outputs the expanded count value to the selection circuit 212.

At time T72, the control pulse P_SEL1 becomes the high level, and at time T73, the control pulse P_SEL1 becomes the low level. By this operation, reading is performed in a period from the time T72 to the time T73.

The selection circuit 212 connects the signal lines of the upper four bits, which are valid data in the count value “12′b0011_1000_0000” output from the selector 251, to the signal lines of the zeroth bit to the third bit of the pixel output signal line 113, respectively. Further, the selection circuit 212 connects the signal line of the upper one bit of the attribute value “2′b00” indicated by the control signal ATTR[1:0] output from the illuminance determination circuit 230 to the signal line of the fourth bit of the pixel output signal line 113.

Therefore, in the period from the time T72 to the time T73, “5′b0_0011” indicating the middle four bits of the count value of the counter circuit 211 and the upper one bit of the attribute value is output to the pixel output signal line 113.

At time T74, the control pulse P_SEL2 becomes the high level, and at time T75, the control pulse P_SEL2 becomes the low level. By this operation, reading is performed in a period from the time T74 to the time T75.

The selection circuit 212 connects the signal lines of the middle four bits, which are valid data in the count value “12′b0011_1000_0000” output from the selector 251, to the signal lines of the zeroth bit to the third bit of the pixel output signal line 113, respectively. The selection circuit 212 connects the signal line of the lower one bit of the attribute value “2′b00” indicated by the control signal ATTR[1:0] output from the illuminance determination circuit 230 to the signal line of the fourth bit of the pixel output signal line 113.

Therefore, in the period from the time T74 to the time T75, “5′b0_1000” indicating the lower four bits of the count value of the counter circuit 211 and the lower one bit of the attribute value is output to the pixel output signal line 113.

At time T76, the second frame period ends. That is, a period from the time T68 to the time T76 is the second frame period. Then, the third frame period starts from the time T76.

After the time T76, the control pulse P_RES becomes the high level, and thereafter, at time T77, the control pulse P_RES becomes the low level. As a result, the count value held in the counter circuit 211 is reset to “0”. Therefore, the count values output from the bit output units 211a, 211b, and 211c are also reset to “0”. The value of the control signal ATTR[1:0] output from the illuminance determination circuit 230 is also reset to “0”.

At time T78, the drive signal CNTEN becomes the high level, and the count operation in the counter circuit 211 starts. That is, the time T78 is the start time of an exposure period. At time T79, the drive signal CNTEN becomes the low level, and the count operation in the counter circuit 211 ends. That is, the time T79 is the end time of the exposure period.

At the time T79, the count value of the counter circuit 211 is “12′b0010_1111_0000”. Therefore, the count value of the bit output unit 211a which is the upper eight bits of the counter circuit 211 is “8′b0010_1111”, and the count value of the bit output unit 211b which is the middle eight bits of the counter circuit 211 is “8′b1011_1100”. The count value of the bit output unit 211c which is the lower eight bits of the counter circuit 211 is “8′b1111_0000”.

According to the Expressions (6) to (9), the control signal A_SEL is “0”, the control signal B_SEL is “1”, and the control signal ATTR[1:0] is “2′b01”. Therefore, the selector 240 selects the count value of the bit output unit 211b. The pixel output circuit 250 expands the 8-bit data output from the selector 240 to 12 bits and inputs the data to the selector 251. At this time, the 8-bit data output from the selector 240 is stored in the upper eight bits of the expanded 12-bit data. Therefore, the count value after expansion becomes “12′b1011_1100_0000”. In the high frame rate mode, the selector 251 outputs the expanded count value to the selection circuit 212.

At time T80, the control pulse P_SEL1 becomes the high level, and at time T81, the control pulse P_SEL1 becomes the low level. By this operation, reading is performed in a period from the time T80 to the time T81.

The selection circuit 212 connects the signal lines of the upper four bits, which are valid data, of the count value “12′b1011_1100_0000” output from the selector 251 to the signal lines of the zeroth bit to the third bit of the pixel output signal line 113, respectively. Further, the selection circuit 212 connects the signal line of the upper one bit of the attribute value “2′b01” indicated by the control signal ATTR[1:0] output from the illuminance determination circuit 230 to the signal line of the fourth bit of the pixel output signal line 113.

Therefore, in the period from the time T80 to the time T81, “5′b0_1011” indicating the upper-middle four bits of the count value of the counter circuit 211 and the upper one bit of the attribute value is output to the pixel output signal line 113.

At time T82, the control pulse P_SEL2 becomes the high level, and at time T83, the control pulse P_SEL2 becomes the low level. By this operation, reading is performed in a period from the time T82 to the time T83.

The selection circuit 212 connects the signal lines of the middle four bits, which are valid data in the count value “12′b1011_1100_0000” output from the selector 251, to the signal lines of the zeroth bit to the third bit of the pixel output signal line 113, respectively. The selection circuit 212 connects the signal line of the lower one bit of the attribute value “2′b01” indicated by the control signal ATTR[1:0] output from the illuminance determination circuit 230 to the signal line of the fourth bit of the pixel output signal line 113.

Therefore, in the period from the time T82 to the time T83, “5′b1_1100” indicating the lower-middle four bits of the count value of the counter circuit 211 and the lower one bit of the attribute value is output to the pixel output signal line 113.

At time T84, the third frame period ends. That is, a period from the time T76 to the time T84 is the third frame period. Description of subsequent operations is omitted.

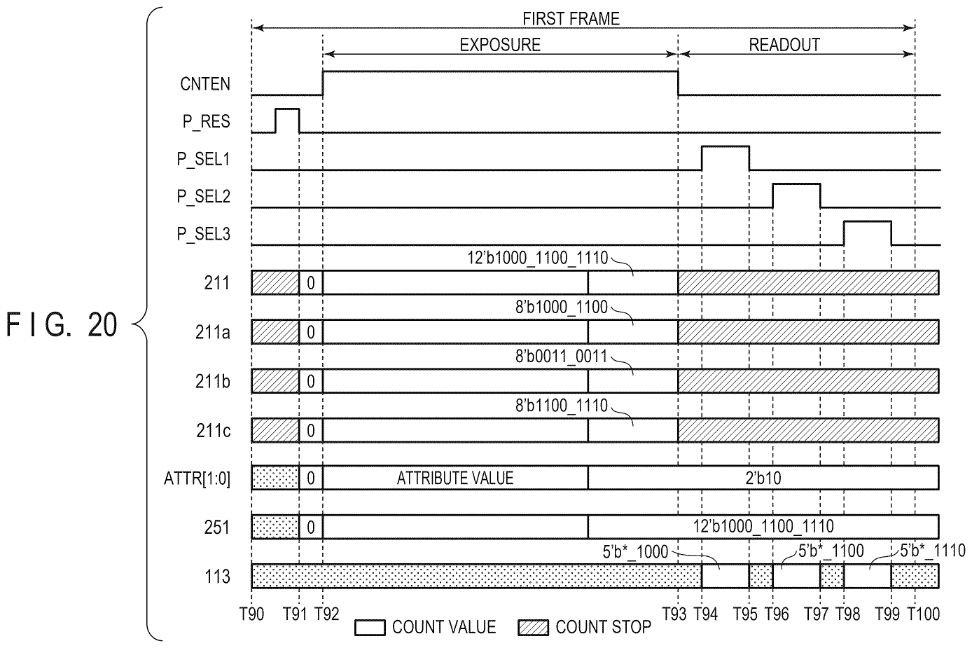

FIG. 20 is a timing chart illustrating an operation of the pixel signal processing unit 103 in the non-high frame rate mode according to the present embodiment. Hereinafter, differences from the high frame rate mode will be described.

Since operations from time T90 to time T93 are the same as the operations from the time T60 to the time T63 in FIG. 19, the description thereof will be omitted. At the time T93, the count value of the counter circuit 211 is “12′b1000_1100_1110”. In the non-high frame rate mode, the selector 251 outputs the count value to the selection circuit 212. That is, in the non-high frame rate mode, the count value of the counter circuit 211 is directly output to the selection circuit 212 regardless of the determination result of the illuminance determination circuit 230.

At time T94, the control pulse P_SEL1 becomes the high level, and at time T95, the control pulse P_SEL1 becomes the low level. By this operation, the upper four bits are read in a period from the time T94 to the time T95.

The selection circuit 212 connects the signal lines of the upper four bits of the count value “12′b1000_1100_1110” output from the selector 251 to the signal lines of the zeroth bit to the third bit of the pixel output signal line 113, respectively. The fourth bit of the pixel output signal line 113 is a don't care bit.

Therefore, in the period from the time T94 to the time T95, “5′b*_1000” indicating the upper four bits of the count value of the counter circuit 211 is output to the pixel output signal line 113.

At time T96, the control pulse P_SEL2 becomes the high level, and at time T97, the control pulse P_SEL2 becomes the low level. By this operation, the middle four bits are read in a period from the time T96 to the time T97.

The selection circuit 212 connects the signal lines of the middle four bits of the count value “12′b1000_1100_1110” output from the selector 251 to the signal lines of the zeroth bit to the third bit of the pixel output signal line 113, respectively. The fourth bit of the pixel output signal line 113 is a don't care bit.

Therefore, in the period from the time T96 to the time T97, “5′b*_1100” indicating the middle four bits of the count value of the counter circuit 211 is output to the pixel output signal line 113.

At time T98, the control pulse P_SEL3 becomes the high level, and at time T99, the control pulse P_SEL3 becomes the low level. By this operation, the lower four bits are read in a period from the time T98 to the time T99.

The selection circuit 212 connects the signal lines of the lower four bits of the count value “12′b1000_1100_1110” output from the selector 251 to the signal lines of the zeroth bit to the third bit of the pixel output signal line 113, respectively. The fourth bit of the pixel output signal line 113 is a don't care bit.

Therefore, in the period from the time T98 to the time T99, “5′b*_1110” indicating the lower four bits of the count value of the counter circuit 211 is output to the pixel output signal line 113. At time T100, the first frame period ends.

Also in the present embodiment, similarly to the first embodiment, a photoelectric conversion device capable of outputting a more appropriate signal according to illuminance is provided. In the present embodiment, in the non-high frame rate mode, reading of each row is performed three times by the control pulses P_SEL1, P_SEL2, and P_SEL3. On the other hand, in the high frame rate mode, reading of each row is performed twice by the control pulses P_SEL1 and P_SEL2. As a result, as compared with the case of the non-high frame rate mode, in the high frame rate mode, the readout time becomes two-thirds, so that a readout speed is 1.5 times faster than in non-high frame rate mode.

In addition, in the present embodiment, the bit output units 211a, 211b, and 211c output data including bits of three kinds of ranges, and the range of bits included in the data to be output can be switched in three stages in accordance with the bits of which the count value has reached. Accordingly, in the present embodiment, data including more valid information can be output as compared with the configuration of the second embodiment.

Also in the present embodiment, the number of bits of the counter circuit 211 can be appropriately changed. For example, the number of bits of data held by the counter circuit 211 (12 bits) may be replaced with N bits (N is an integer equal to or greater than two). In addition, the number of bits of data output from each of the bit output units 211a, 211b, and 211c (eight bits) may be replaced with M bits (M is an integer equal to or greater than one and less than N). From the viewpoint of overlapping the ranges of bits of data output from the bit output units 211a, 211b, and 211c, it is preferable that N is equal to or less than 3M. As in the specific example of the present embodiment, typically, N equals to 1.5M. The pixel output signal line 113 may include (M/2+1) signal lines or (N/3+1) signal lines. The configuration and operation of the present embodiment are generalized by the above-described replacement.

In addition, the number of readings of each row in the non-high frame rate mode and the number of readings of each row in the high frame rate mode can also be appropriately changed. It is assumed that the number of readings of each row in the non-high frame rate mode is R, and the number of readings of each row in the high frame rate mode is Q. Here, Q may be an integer equal to or greater than two, R may be an integer equal to or greater than three, and R may be greater than Q.

### Fifth Embodiment

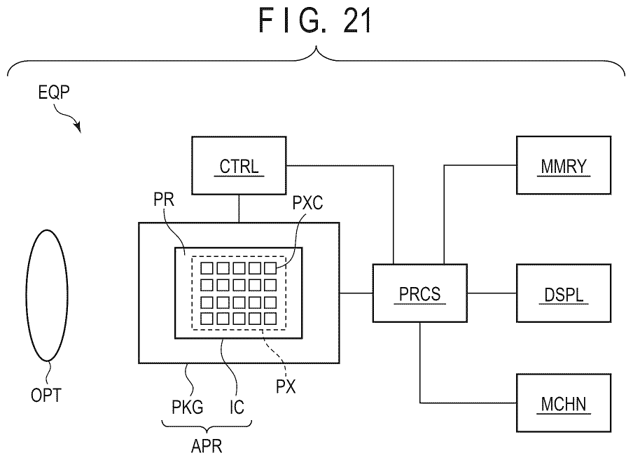

Equipment according to a fifth embodiment will be described with reference to FIG. 21. FIG. 21 is a block diagram illustrating a schematic configuration of equipment according to the present embodiment.

FIG. 21 is a schematic diagram illustrating equipment EQP including a photoelectric conversion device APR. The photoelectric conversion device APR has the function of the photoelectric conversion device 100 according to the first to fourth embodiments. All or part of the photoelectric conversion device APR is a semiconductor device IC. The photoelectric conversion device APR of this example can be used as, for example, an image sensor, an auto focus (AF) sensor, a photometric sensor, a ranging sensor, or the like. The semiconductor device IC has a pixel area PX in which pixel circuits PXC each including photoelectric conversion unit are arranged in a matrix. The semiconductor device IC may have a peripheral area PR around the pixel area PX. Circuits other than the pixel circuits can be arranged in the peripheral area PR.

The photoelectric conversion device APR may have a structure (stacked chips structure) in which a first semiconductor chip provided with a plurality of photoelectric conversion units and a second semiconductor chip provided with a peripheral circuit are stacked. Each of the peripheral circuits in the second semiconductor chip may be a column circuit corresponding to a pixel column of the first semiconductor chip. Each of the peripheral circuits in the second semiconductor chip may be a matrix circuit corresponding to a pixel or a pixel block in the first semiconductor chip. For the connection between the first semiconductor chip and the second semiconductor chip, a through electrode (TSV), an inter-chip wiring by direct bonding of a conductor such as copper, a connection by a micro bump between chips, a connection by wire bonding, or the like can be employed.

The photoelectric conversion device APR may include a package PKG for mounting the semiconductor device IC in addition to the semiconductor device IC. The package PKG may include a base body to which the semiconductor device IC is fixed, a lid such as glass facing the semiconductor device IC, and a connection member such as a bonding wire or a bump for connecting a terminal provided on the base body and a terminal provided on the semiconductor device IC.

The equipment EQP may further include at least one of an optical device OPT, a control device CTRL, a processing device PRCS, a display device DSPL, a storage device MMRY, and a mechanical device MCHN. The optical device OPT corresponds to the photoelectric conversion device APR, and is, for example, a lens, a shutter, or a mirror. The control device CTRL controls the photoelectric conversion device APR, and is, for example, a semiconductor device such as an ASIC.

The processing device PRCS processes a signal output from the photoelectric conversion device APR, and constitutes an analog front end (AFE) or a digital front end (DFE). The processing device PRCS is a semiconductor device such as a central processing unit (CPU) or an application specific integrated circuit (ASIC). The display device DSPL is an EL display device, a liquid crystal display device, or the like that displays information (image) obtained by the photoelectric conversion device APR. The storage device MMRY is a magnetic device, a semiconductor device, or the like that stores information (image) obtained by the photoelectric conversion device APR. The storage device MMRY is a volatile memory such as an SRAM or a DRAM, or a nonvolatile memory such as a flash memory or a hard disk drive.

The mechanical device MCHN includes a movable portion or a propulsion portion such as a motor or an engine. In the equipment EQP, a signal output from the photoelectric conversion device APR is displayed on the display device DSPL or transmitted to the outside by a communication device (not illustrated) included in the equipment EQP. Therefore, it is preferable that the equipment EQP further include a storage device MMRY and a processing device PRCS separately from the storage circuit unit and the arithmetic circuit unit included in the photoelectric conversion device APR. The mechanical device MCHN may be controlled based on a signal output from the photoelectric conversion device APR.

The equipment EQP illustrated in FIG. 21 may be an electronic device such as an information terminal (for example, a smartphone and a wearable terminal) having a photographing function, a camera (For example, an interchangeable lens camera, a compact camera, a video camera, and a surveillance camera), or the like. The mechanical device MCHN in the camera may drive parts of the optical device OPT for zooming, focusing, and shutter operation. Also, the equipment EQP may be a transport device (movable body) such as a vehicle, a ship, a drone, or an airplane. The equipment EQP may be a medical device such as an endoscope or a CT scanner. The equipment EQP may be a measurement device such as a ranging sensor, an analysis device such as an electron microscope, an office device such as a copier, or an industrial device such as a robot.

The mechanical device MCHN in the transport device may be used as a movable device. The equipment EQP as a transport device is suitable for transporting the photoelectric conversion device APR, or for assisting and/or automating driving (manipulation) by an imaging function. The processing device PRCS for assisting and/or automating driving (manipulation) may perform processing for operating the mechanical device MCHN as a movable device based on information obtained by the photoelectric conversion device APR.

According to the first to fourth embodiments, signal acquisition can be performed satisfactorily. Therefore, the photoelectric conversion device APR according to the first to fourth embodiments may provide a high value to a designer, a manufacturer, a seller, a purchaser, and/or a user thereof. Therefore, when the photoelectric conversion device APR is mounted on the equipment EQP, the value of the equipment EQP may also be increased. Therefore, in manufacturing and selling the equipment EQP, it is advantageous to determine the mounting of the photoelectric conversion device APR of the present embodiment on the equipment EQP in order to increase the value of the equipment EQP. Here, increasing the value corresponds to at least one of adding a function, improving performance, improving characteristics, improving reliability, improving manufacturing yield, reducing environmental load, reducing cost, reducing size, and reducing weight.

For example, by mounting the photoelectric conversion device APR in a transport device, it is possible to obtain excellent performance when photographing outside the transport device or measuring an external environment. Therefore, in manufacturing and selling the transport device, it is advantageous to determine the mounting of the photoelectric conversion device APR according to the present embodiment on the transport device in order to improve the performance of the transport device itself. In particular, the photoelectric conversion device APR is suitable for a transport device that performs driving support and/or automatic driving of the transport device using information obtained by the photoelectric conversion device APR.

### Sixth Embodiment

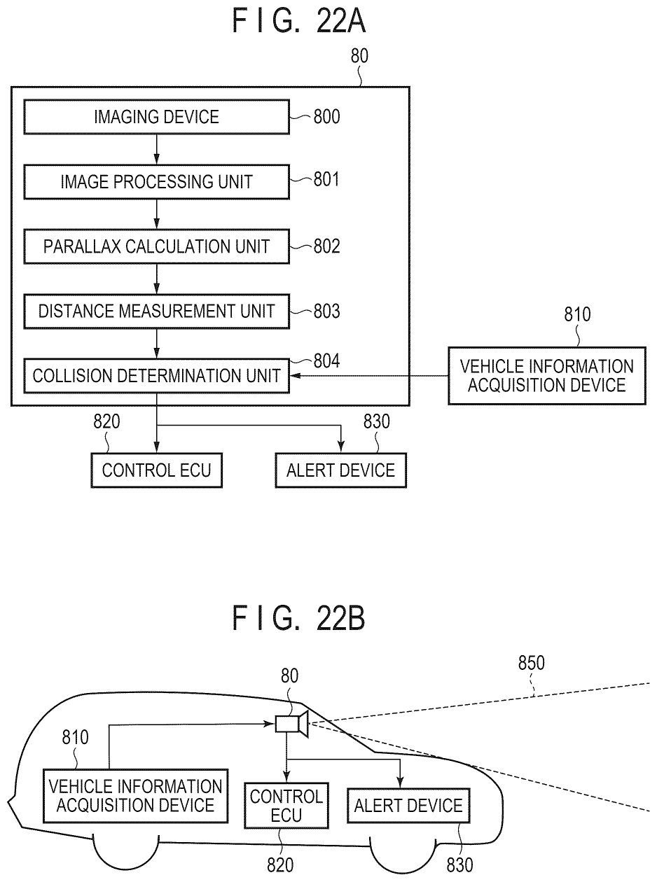

FIGS. 22A and 22B are block diagrams of equipment relating to the vehicle-mounted camera according to the present embodiment. FIGS. 22A and 22B illustrate an example in which the above-described photoelectric conversion device is applied to a movable body such as a vehicle. The equipment 80 includes an imaging device 800 (an example of the photoelectric conversion device) and a signal processing device (processing device) that processes a signal from the imaging device 800. The equipment 80 includes an image processing unit 801 that performs image processing on a plurality of pieces of image data acquired by the imaging device 800, and a parallax calculation unit 802 that calculates parallax (phase difference of parallax images) from the plurality of pieces of image data acquired by the equipment 80.

Here, the equipment 80 may include an optical system (not illustrated) that guides light to the imaging device 800. The optical system may include, for example, a lens, a shutter, and a mirror. A plurality of photoelectric conversion units substantially conjugate to the pupil of the optical system may be arranged in a pixel included in the imaging device 800. For example, a plurality of photoelectric conversion units are arranged corresponding to one microlens. The plurality of photoelectric conversion units may receive light fluxes transmitted through different positions of the pupil of the optical system. Thus, the imaging device 800 outputs a plurality of pieces of image data respectively corresponding to the light fluxes transmitted through different positions of the pupil of the optical system. Then, the parallax calculation unit 802 may calculate the parallax using the plurality of pieces of image data being output.

The equipment 80 includes a distance measurement unit 803 that calculates a distance to an object based on the calculated parallax, and a collision determination unit 804 that determines whether or not there is a possibility of collision based on the calculated distance. Here, the parallax calculation unit 802 and the distance measurement unit 803 are examples of a distance information acquisition unit that acquires distance information to the object. That is, the distance information is information on a parallax, a defocus amount, a distance to the object, and the like. The collision determination unit 804 may determine the possibility of collision using any of these pieces of distance information. Note that the distance information may be acquired using a time of flight (ToF) technique. The distance information acquisition unit may be realized by dedicatedly designed hardware or software modules. Further, it may be realized by a field programmable gate array (FPGA), an application specific integrated circuit (ASIC) or a combination thereof.

The equipment 80 is connected to the vehicle information acquisition device 810, and can obtain vehicle information such as a vehicle speed, a yaw rate, and a steering angle. Further, the equipment 80 is connected to a control ECU 820 which is a control device that outputs a control signal for generating a braking force to the vehicle based on the determination result of the collision determination unit 804. The equipment 80 is also connected to an alert device 830 that issues an alert to the driver based on the determination result of the collision determination unit 804. For example, when the collision possibility is high as the determination result of the collision determination unit 804, the control ECU 820 performs vehicle control to avoid collision or reduce damage by braking, returning an accelerator, suppressing engine output, or the like. The alert device 830 alerts the user by sounding an alarm such as a sound, displaying alert information on a screen of a car navigation system or the like, or giving vibration to a seat belt or a steering wheel. The equipment 80 functions as a control unit that controls the operation of controlling the vehicle as described above.

In the present embodiment, an image of the periphery of the vehicle, for example, the front or the rear is captured by the equipment 80. FIG. 22B illustrates equipment in a case where an image is captured in front of the vehicle (image capturing range 850). The vehicle information acquisition device 810 as the imaging control unit sends an instruction to the equipment 80 or the imaging device 800 to perform the imaging operation. With such a configuration, the accuracy of distance measurement can be further improved.

Although the example of control for avoiding a collision to another vehicle has been described above, the embodiment is applicable to automatic driving control for following another vehicle, automatic driving control for not going out of a traffic lane, or the like. Furthermore, the equipment is not limited to a vehicle such as an automobile and can be applied to a movable body (movable apparatus) such as a ship, an airplane, a satellite, an industrial robot and a consumer use robot, or the like, for example. In addition, the equipment can be widely applied to equipment which utilizes object recognition or biometric authentication, such as an intelligent transportation system (ITS), a surveillance system, or the like without being limited to movable bodies.

### Seventh Embodiment

The switching between the high frame rate mode and the non-high frame rate mode in the photoelectric conversion device 100 described above is performed by a processing circuit of equipment on which the photoelectric conversion device 100 is mounted as described in the fifth embodiment or the sixth embodiment. The processing circuit may be, for example, the processing device PRCS of the fifth embodiment or the image processing unit 801 of the sixth embodiment. In the present embodiment, a specific example in which the high frame rate mode and the non-high frame rate mode are switched by feedback control from a processing circuit in a subsequent stage of the photoelectric conversion device 100 will be described.

In the present embodiment, a processing circuit that performs subsequent processing acquires information indicating brightness of an imaging scene. Then, the processing circuit performs feedback control to the photoelectric conversion device 100 so that the high frame rate mode is applied when the brightness is equal to or less than a predetermined threshold value. On the other hand, the processing circuit performs feedback control to the photoelectric conversion device 100 so that the non-high frame rate mode is applied when the brightness is greater than the predetermined threshold value. The processing circuit switches between the high frame rate mode and the non-high frame rate mode by changing the mode setting value.

In the high frame rate mode, since a part of bits of the counter circuit 211 are read out, the amount of data to be read out is smaller than in the case of the non-high frame rate mode in which all bits of the counter circuit 211 are read out, and the gradation may be lowered. However, in the present embodiment, since the high frame rate mode is applied to a dark scene in which the upper bits are often “0”, the high frame rate mode can be applied without substantially lowering the gradation. On the other hand, when in a bright scene, since the non-high frame rate mode is applied, a decrease in gradation can be avoided. Therefore, according to the present embodiment, it is possible to reduce the influence of the reduction in gradation due to the application of the high frame rate mode.

Note that the acquisition of the illuminance information is performed by, for example, acquiring information indicating brightness of an object such as an accumulated value of pixel values from a captured image. Some digital cameras such as surveillance cameras employ an automatic exposure (AE) function for automatically performing exposure adjustment so that the brightness of a captured image becomes appropriate regardless of the actual brightness of an object. A technique similar to the technique of acquiring brightness in the AE function can be applied to the acquisition of illuminance information in the present embodiment.

### Eighth Embodiment

In the present embodiment, another example of switching between the high frame rate mode and the non-high frame rate mode described in the seventh embodiment will be described.

In the present embodiment, a processing circuit that performs subsequent processing acquires motion information of an object. Then, the processing circuit performs feedback control to the photoelectric conversion device 100 so that the high frame rate mode is applied when magnitude of a motion of the object is equal to or less than a predetermined threshold value. On the other hand, the processing circuit performs feedback control to the photoelectric conversion device 100 so that the non-high frame rate mode is applied when the magnitude of the motion of the object is greater than the predetermined threshold value. To acquire the motion information of the object, for example, a method of calculating a motion vector of an image used for motion surveillance or the like may be used.

In the present embodiment, it is possible to capture an image at a high frame rate in the high frame rate mode in a scene in which the motion of the object is small, and it is possible to capture a detailed image at a high gradation in the non-high frame rate mode in a scene in which the motion of the object is large. Therefore, according to the present embodiment, it is possible to perform more appropriate imaging in consideration of the motion of the object.

Examples of equipment to which the photoelectric conversion device 100 is applied include digital cameras such as surveillance cameras. In this case, it is possible to perform high-speed imaging in the high frame rate mode in a normal state, and it is possible to perform detailed imaging of the object by applying the non-high frame rate in a scene in which the motion of the object is large such as a case where there is a suspicious person. As described above, the method of the present embodiment can be used in a use case of motion surveillance.

The relationship between the motion information and the threshold value may be opposite to that in the above-described example. That is, the processing circuit may perform feedback control to the photoelectric conversion device 100 so that the high frame rate mode is applied when the magnitude of the motion of the object is greater than a predetermined threshold value. In addition, the processing circuit may perform feedback control to the photoelectric conversion device 100 so that the non-high frame rate mode is applied when the magnitude of the motion of the object is equal to or less than the predetermined threshold value. In this example, in a scene in which the motion of the object is small, detailed imaging at a high gradation can be performed in the non-high frame rate mode, and in a scene in which the motion of the object is large, imaging can be performed while reducing the blur of the object moving fast in the high frame rate mode. This can improve recognition efficiency in motion detection.

### Ninth Embodiment

In the seventh embodiment and the eighth embodiment, an example in which the high frame rate mode and the non-high frame rate mode are switched according to the situation is described. However, the high frame rate mode and the non-high frame rate mode may be switched according to regions of an image. In the present embodiment, an example will be described in which an image is divided into a plurality of regions, and either the high frame rate mode or the non-high frame rate mode is applied to each region.

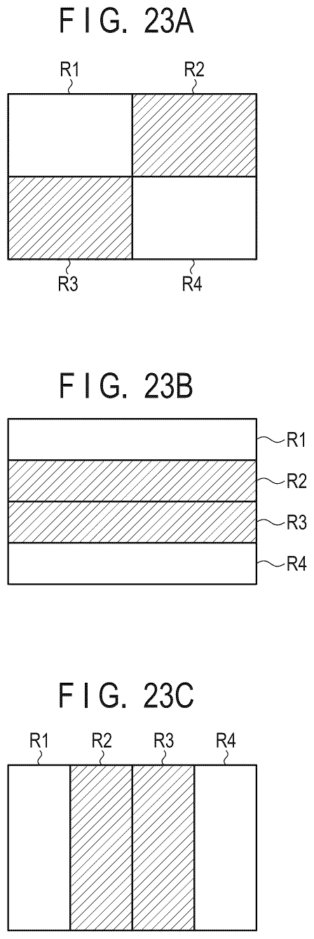

FIGS. 23A, 23B, and 23C are diagrams illustrating setting regions of the high frame rate mode and the non-high frame rate mode according to the present embodiment. In FIGS. 23A, 23B, and 23C, hatched regions indicate regions to which the high frame rate mode is applied, and unhatched regions indicate regions to which the non-high frame rate mode is applied.

FIG. 23A illustrates an example in which an image is divided into four regions R1, R2, R3, and R4 by dividing the image into two in the vertical and horizontal directions. Among the four regions R1, R2, R3, and R4, the high frame rate mode is applied to the upper right region R2 and the lower left region R3, and the non-high frame rate mode is applied to the upper left region R1 and the lower right region R4. For example, the frame rate in the high frame rate mode is 60 fps, and the frame rate in the non-high frame rate mode is 30 fps. The signals corresponding to the four regions R1, R2, R3, and R4 may be processed by four digital front ends corresponding to the four regions R1, R2, R3, and R4, respectively, in subsequent processing. The mode applied to each of the four regions R1, R2, R3, and R4 may be fixed, or may be dynamically switchable for each region according to the situation.

FIG. 23B is a modification of the region dividing method. FIG. 23B illustrates an example in which an image is divided into four regions R1, R2, R3, and R4 by being vertically divided into four regions. Among the four regions R1, R2, R3, and R4, the high frame rate mode is applied to the inner regions R2 and R3, and the non-high frame rate mode is applied to the upper region R1 and the lower region R4.

FIG. 23C is a modification of the region dividing method. FIG. 23C illustrates an example in which an image is divided into four regions R1, R2, R3, and R4 by being horizontally divided into four regions. Among the four regions R1, R2, R3, and R4, the high frame rate mode is applied to the inner regions R2 and R3, and the non-high frame rate mode is applied to the left region R1 and the right region R4.

As described above, according to the present embodiment, it is possible to perform an operation of selectively using the high frame rate mode and the non-high frame rate mode for each region in the image. In addition, the method of the present embodiment is effective in a case where an appropriate frame rate can be different depending on a position in the image.

Other Embodiments

The present disclosure is not limited to the above embodiments, and various modifications are possible. For example, an example in which some of the configurations of any one of the embodiments are added to other embodiments or an example in which some of the configurations of any one of the embodiments are replaced with some of the configurations of other embodiments are also embodiments of the present disclosure.

FIGS. 6, 10, 14, and 16 illustrate an example in which the illuminance determination circuit 230 is arranged in the pixel signal processing unit 103 of each pixel. However, it is not essential that the illuminance determination circuit 230 is arranged in the pixel signal processing unit 103 of all the pixels. For example, the pixel signal processing units 103 of a plurality of pixels such as four pixels of two rows and two rows and sixteen pixels of four rows and four columns may share one illuminance determination circuit 230. Accordingly, the number of illuminance determination circuits 230 can be reduced, and the circuit scale of the photoelectric conversion device 100 can be reduced. In addition, the photoelectric conversion device 100 can be enhanced in function by adding another circuit to the free area due to the reduction in the total number of the illuminance determination circuits 230. In this case, for example, the determination result in the illuminance determination circuit 230 of one pixel signal processing unit 103 can also be applied to a plurality of pixel signal processing units 103 including neighboring pixel signal processing units 103.

In addition, a plurality of count values may be input from the bit output units 211a of a plurality of pixel signal processing units 103 to one illuminance determination circuit 230, and the illuminance determination circuit 230 may perform determination based on the plurality of count values.

Almost no light is incident on the photoelectric conversion unit 102 in the OB region 15 illustrated in FIG. 2. Therefore, the illuminance determination circuit 230 may not be arranged in the pixel signal processing unit 103 (light-shielded pixel circuit) arranged in the region 25 of FIG. 3 corresponding to the OB region 15. For example, in the example of the pixel signal processing unit 103 in FIGS. 6 and 10, the value is not carried in the LSB of the data output from the bit output unit 211a in the region 25. Therefore, the selector 240 may be configured to always select the count value of the bit output unit 211b without performing the illuminance determination. Similarly, in the example of FIG. 14, the selector 240 may be configured to always select the count value of the bit output unit 211c, and in the example of FIG. 16, the selector 240 may be configured to always select the count value of the bit output unit 211b. Therefore, since the illuminance determination circuit 230 is not necessary in the pixel signal processing unit 103 arranged in the region 25, the illuminance determination circuit 230 can be omitted. Accordingly, the number of illuminance determination circuits 230 can be reduced, and the circuit scale of the photoelectric conversion device 100 can be reduced. In addition, the photoelectric conversion device 100 can be enhanced in function by adding another circuit to the free area due to the reduction in the total number of the illuminance determination circuits 230.

The embodiments described above can be appropriately modified without departing from the technical idea. Note that the disclosure of the present specification includes not only the matters described in the present specification but also all matters that can be grasped from the present specification and the drawings attached to the present specification. Also, the disclosure of the present specification includes a complementary set of the concepts described in the present specification. In other words, for example, when there is a description of “A is greater than B” in the present specification, it can be said that the description of “A is not greater than B” is disclosed in the present specification even when the description of “A is not greater than B” is omitted. This is because it is assumed that the case where “A is not greater than B” is considered when “A is greater than B” is described.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

It should be noted that the above-described embodiments are merely specific examples for carrying out the present disclosure, and the technical scope of the present disclosure should not be interpreted in a limited manner by these embodiments. That is, the present disclosure can be implemented in various forms without departing from the technical idea or the main features thereof.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-021357, filed Feb. 13, 2025, which is hereby incorporated by reference herein in its entirety.

What is claimed is:

1. A photoelectric conversion device comprising:
an avalanche photodiode configured to output a signal according to incident light;
a pulse generation circuit configured to generate a pulsed signal based on an output signal from the avalanche photodiode;
a counter configured to generate and hold a first count value of N bits by counting the number of pulses included in the pulsed signal, where N is an integer equal to or greater than two;
an illuminance determination circuit configured to generate an illuminance signal that indicates illuminance based on a value of at least a part of bits of the first count value;
a selector configured to output a second count value of M bits in the first count value, where M is an integer equal to or greater than one, and M is less than N; and
an output circuit configured to output data based on the first count value or the second count value,
wherein the selector selects a range of bits of the second count value in the first count value based on the illuminance signal.

2. The photoelectric conversion device according to claim 1,
wherein in a first mode, the output circuit outputs a value of a part of bits of the first count value based on the second count value, and
wherein in a second mode, the output circuit outputs values of all bits of the first count value based on the first count value.

3. The photoelectric conversion device according to claim 2, wherein a frame rate in the first mode is higher than a frame rate in the second mode.

4. The photoelectric conversion device according to claim 2 comprising a plurality of the avalanche photodiodes arranged two-dimensionally,
wherein data based on incident light to an avalanche photodiode in a partial region of the plurality of avalanche photodiodes is output in the first mode, and data based on incident light to an avalanche photodiode in another partial region of the plurality of avalanche photodiodes is output in the second mode.

5. The photoelectric conversion device according to claim 2, wherein when brightness of an imaging scene is equal to or less than a threshold value, the data is output in the first mode, and when the brightness is greater than the threshold value, the data is output in the second mode.

6. The photoelectric conversion device according to claim 2, wherein when magnitude of a motion of an object in a captured image is equal to or less than a threshold value, the data is output in the first mode, and when the magnitude of the motion of the object is greater than the threshold value, the data is output in the second mode.

7. The photoelectric conversion device according to claim 2, wherein when magnitude of a motion of an object in a captured image is greater than a threshold value, the data is output in the first mode, and when the magnitude of the motion of the object is equal to or less than the threshold value, the data is output in the second mode.

8. The photoelectric conversion device according to claim 1 comprising a plurality of pixel circuits each including the avalanche photodiode, the pulse generation circuit, the counter, the selector, and the output circuit, the plurality of pixel circuits being arranged to form a plurality of rows,
wherein a range of bits of the second count value that is output by the selector in a first row of the plurality of rows and a range of bits of the second count value that is output by the selector in a second row of the plurality of rows are different from each other.

9. The photoelectric conversion device according to claim 8,
wherein in a first mode, the output circuit simultaneously outputs a value of a part of bits of the first count value of the first row and a value of a part of bits of the first count value of the second row based on the second count value of the first row and the second count value of the second row, and
wherein in a second mode, the output circuit outputs values of all bits of the first count value of the first row based on the first count value of the first row.

10. The photoelectric conversion device according to claim 1, wherein the selector selects, from the first count value, either a first range of M bits including a most significant bit of the first count value or a second range of M bits including a least significant bit of the first count value, and outputs a selected value as the second count value.

11. The photoelectric conversion device according to claim 10, wherein the first range and the second range do not overlap.

12. The photoelectric conversion device according to claim 10,
wherein in a first mode, the output circuit outputs a value of a part of bits of the first count value based on the second count value, and
wherein in a second mode, the output circuit outputs values of all bits of the first count value based on the first count value by a plurality of output operations.

13. The photoelectric conversion device according to claim 1, wherein the selector selects, from the first count value, a first range of M bits including a most significant bit of the first count value, a second range of M bits including a least significant bit of the first count value, or a third range of M bits not including both the most significant bit and the least significant bit of the first count value, and outputs a selected value as the second count value.

14. The photoelectric conversion device according to claim 13,
wherein a part of the first range and a part of the third range overlap, and
wherein a part of the second range and a part of the third range overlap.

15. The photoelectric conversion device according to claim 14,
wherein in a first mode, the output circuit outputs a value of a part of bits of the first count value based on the second count value, and
wherein in a second mode, the output circuit outputs values of all bits of the first count value based on the first count value by a plurality of output operations.

16. The photoelectric conversion device according to claim 14,
wherein in a first mode, the output circuit outputs values of a part of bits of the first count value based on the second count value by Q times of output operations, where Q is an integer equal to or greater than two, and
wherein in a second mode, the output circuit outputs values of all bits of the first count value based on the first count value by R times of output operations, where R is an integer equal to or greater than three, and R is greater than Q.

17. The photoelectric conversion device according to claim 1, wherein when all bits in a range of M bits including a most significant bit of the first count value are zero, the selector selects a range of bits of the second count value so as not to include the most significant bit.

18. The photoelectric conversion device according to claim 1, comprising:
a pixel circuit including the avalanche photodiode, the pulse generation circuit, the counter, the selector, and the output circuit; and
a light-shielded pixel circuit including the avalanche photodiode, the pulse generation circuit, the counter, the selector, and the output circuit, the avalanche photodiode of the light-shielded pixel circuit being shielded from light,
wherein the selector of the light-shielded pixel circuit selects a range of bits of the second count value so as to include a least significant bit of the first count value regardless of the illuminance signal.

19. Equipment comprising:
the photoelectric conversion device according to claim 1; and
at least any one of:
an optical device adapted for the photoelectric conversion device,
a control device configured to control the photoelectric conversion device,
a processing device configured to process a signal output from the photoelectric conversion device,
a display device configured to display information obtained by the photoelectric conversion device,
a storage device configured to store information obtained by the photoelectric conversion device, and
a mechanical device configured to operate based on information obtained by the photoelectric conversion device.

20. The equipment according to claim 19, wherein the processing device acquires distance information from the photoelectric conversion device to an object.
